(19) United States
(12) Patent Application Publication
(10) Pub. No.: US 2003/0112973 A1
(43) Pub. Date: Jun. 19, 2003

(54) Signal processing method and apparatus, and code string generating method and apparatus

(76) Inventors: Kyoya Tsutsui, Kanagawa (JP); Naoya Haneda, Tokyo (JP); Kenzo Akagiri, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/289,844

(22) Filed: Nov. 7, 2002

(30) Foreign Application Priority Data
Nov. 7, 2001 (JP) P2001-342354

(51) Int. Cl. H04L 9/00

(52) U.S. Cl. 380/46

(57) ABSTRACT

A signal of a first code string, in which a code string in a predetermined format is partially replaced with dummy data, is transferred to a code string rewriting unit via a code string decomposition unit. A signal of a second code string for replacing the dummy data in the signal of the first code string is transferred to a control unit, and the amount of dummy data in a mid-range spectrum is calculated in a mid-range spectrum dummy data amount calculation unit. The control unit transfers data for replacing the dummy data to the code string rewriting unit, where the dummy data in the first code string is rewritten therewith.

### BACKGROUND OF THE INVENTION

1. Field of the Invention

The present invention relates to signal processing methods and apparatuses and to code string generating methods and apparatuses, for example, to a signal processing method and apparatus and a code string generating method and apparatus in which signals are encoded so as to allow previewing and in which a person that purchases data after previewing is allowed to play or record the data in high quality by adding a small amount of data.

2. Description of the Related Art

Methods of distributing content (software) are known in which, for example, audio signals in an encrypted form are broadcast or recorded on a recording medium so that only a person that purchases a decryption key will be allowed to enjoy the content.

For example, in a known method of encryption, a seed for a random number sequence is assigned as a key signal to a bit sequence of PCM audio signal, the PCM bit sequence is exclusive-ORed with a random number sequence of 0s and 1s generated from the seed, and a bit sequence thus generated is transmitted or recorded on a recording medium. According to this method, only a person that has obtained the key signal is allowed to play the audio signal correctly, while a person without the key signal is only allowed to hear noise. Obviously, more complex encryption methods may be used, such as DES (Data Encryption Standard). DES is described in “Feral Information Processing Standards Publication 46, Specifications for the DATA ENCRYPTION STANDARD, Jan. 15, 1997”.

Also, methods of broadcasting compressed audio signals or recording them on a recording medium are widespread, and recording media such as magneto-optical disks that allow recording of encoded audio or speech signals, etc. are widely used.

Various methods of efficiently encoding audio or speech signals exist. Examples include sub-band coding (SBC), which is a type of non-block frequency band split coding, in which audio signals, etc. are not grouped into blocks on the time axis and the signals are split into a plurality of frequency bands for encoding; and transform coding, which is a type of block frequency band split coding, in which signals on the time axis are spectral-transformed into signals on the frequency axis and then split into a plurality of frequency bands for encoding. Furthermore, an efficient coding method based on a combination of sub-band coding and transform coding has been proposed. According to that method, for example, signals are split into bands by sub-band coding, signals in the respective bands are spectral-transformed into signals on the frequency axis, and the signals on the frequency axis in the respective bands are encoded.

The band splitting described above is implemented, for example, by one or more QMFs (quadrature mirror filters). QMFs are described in “R. E. Crochiere, Digital coding of speech in subbands, Bell Syst. Tech. J. Vol.55, No.8, 1976”. Also, “ICASSP 83, BOSTON, Polyphase Quadrature filters—A new subband coding technique, Joseph H. Rothweiler” describes a method of filter-splitting into equal bandwidths.

The spectral transform described above is implemented, for example, by grouping input audio signals into blocks by units of a predetermined time (frame) and executing discrete Fourier transform (DFT), discrete cosine transform (DCT), modified discrete cosine transform (MDCT), or the like, on each of the blocks for transform from time axis to frequency axis. MDCT is described in “ICASSP, 1987, Subband/Transform Coding Using Filter Bank Designs Based on Time Domain Aliasing Cancellation, J. P. Princen, A. B. Bradley, Univ. of Surrey Royal Melbourne Inst. of Tech.”

When DFT or DCT is used for spectral transform of a waveform signal, if transform is performed on the basis of time blocks each consisting of M samples, M independent real-number data are obtained. In order to alleviate distortion associated with blocks, usually, M1 samples are overlapped with each of the adjacent blocks on both sides. Thus, in DFT or DCT, on average, M real-number data is quantized and encoded for each set of (M−M1) samples.

As opposed to DFT and DCT, if MDCT is used for spectral transform, M independent real-number data is obtained from 2M samples overlapped by M samples with each of the adjacent blocks on both sides. Thus, in MDCT, on average, M real-number data is quantized and encoded for each set of M samples. In a decoding apparatus, codes obtained by MDCT in each block are inversely transformed to obtain waveform components, and the waveform components are added so as to interfere with each other, whereby a waveform signal is reconstructed.

Generally, use of longer time blocks for transform improves frequency resolution of spectrum, and causes energy to concentrate in particular spectrum components. Thus, by using MDCT, in which long blocks that are half-overlapped with each of the adjacent blocks on both sides are used for transform and in which the number of spectrum signals obtained does not increase relative to the number of original samples, more efficient coding is allowed compared with DFT and DCT. Furthermore, distortion of waveform signals associated with blocks can be reduced by providing sufficient overlaps between adjacent blocks.

By quantizing signals split into bands by a filter and spectral transform, occurrence of quantization noise can be contained within a particular band, and more efficient coding is allowed using the masking effect, etc. Furthermore, even more efficient coding is allowed by normalizing signal components in each band by the maximum absolute value in the band.

The bandwidth for splitting bands and quantizing frequency components in the respective bands is determined with consideration of characteristics of human auditory perception. More specifically, audio signals are split into a plurality of bands (e.g., 25 bands) on the basis of critical bands, in which bandwidth becomes larger as the band goes higher. When data in the respective bands is encoded, bits are allocated to the respective bands in a predetermined manner or adaptively. For example, coefficient data obtained by MDCT is encoded by allocating bits, bits are adaptively allocated to MDCT coefficient data for the respective bands, obtained by executing MDCT on the block basis.

Two methods of bit allocation are known. One is disclosed in “Adaptive Transform Coding of Speech Signals, R. Zelinski and P. Noll, IEEE Transactions of Acoustics, Speech, and Signal Processing, vol. ASSP-25, No.4, August 1977”, in which bits are allocated on the basis of magnitude of signals in each band. According to this method, spectrum of quantization noise is flat and noise energy is minimized. However, actual perception of noise is not optimal since masking effect is not utilized for auditory perception. The other is disclosed in “ICASSP 1980, The critical band coder—digital encoding of the perceptual requirements of the auditory system, M. A. Kransner, MIT”, in which fixed number of bits are allocated based on signal to noise ratio required for each band using auditory masking. However, according to this method, since allocation of bits is fixed, characteristics are not significantly improved even in a case of input of a sine wave.

In order to overcome these problems, in a proposed efficient encoding apparatus, bits to be allocated are divided into bits for fixed bit allocation predetermined for each block and bits to be distributed depending on the magnitude of signals in each block, the division ratio depends on a signal related to an input signal, and the ratio of bits for fixed bit allocation is increased as spectrum of the signal becomes more smooth.

According to this method, if energy is concentrated to particular spectrum components as in the case of input of a sine wave, more bits are allocated to blocks including the spectrum components, which significantly improves the overall signal to noise ratio. Generally, human auditory perception is very sensitive to signals having sharp spectrum components, using the above method and thereby improving signal to noise ratio is effective not only to improve measured characteristics but also to improve sound quality in terms of auditory perception.

Many other methods of bit allocation have been proposed, and more efficient encoding is possible by modeling the auditory system more precisely and improving performance of encoding apparatus. In these methods, usually, reference real numbers for bit allocation that most closely achieve calculated signal-to-noise characteristics are obtained, and integer values approximating the reference values are used as the numbers of bits to be allocated.

In the specification and drawings of Japanese Patent Application No. 5-152865, or PCT Application No. 1994/JP/00880 (WO94/28633), proposed earlier by one of the inventors of the present invention and other one inventor, an encoding method is proposed in which a tone component that is particularly significant for auditory perception, i.e., a signal component around a particular frequency at which energy is concentrated, is separated from a spectrum signal and encoded separately from other spectrum components. According to this method, audio signals, etc. can be efficiently encoded at a high compression rate without substantially degrading audible sound quality.

When an actual code string is formed, first, quantization precision information and normalization coefficient information are encoded in predetermined numbers of bits in each band for normalization and quantization. Then, normalized and quantized spectrum signals are encoded. ISO/IEC 11172-3: 1993(E), 1993 dictates an efficient encoding method in which the number of bits representing quantization precision information differs from band to band, the number of bits representing quantization precision information being smaller as the band goes higher.

In a known method, in a decoding apparatus, for example, quantization precision information is determined from normalization coefficient information (or normalization factor information) instead of directly encoding quantization precision information. According to this method, however, relationship between normalization coefficient information and quantization precision information is determined when the standard is defined, prohibiting future introduction of quantization precision based on a more sophisticated auditory model. Furthermore, if a range of compression rates is to be implemented, relationship between normalization coefficient information and quantization precision information must be defined for each of the compression rates.

A method of encoding quantized spectrum signals more efficiently using variable-length codes is known, which is described, for example, in “D. A. Huffman: A Method for Construction of Minimum Redundancy Codes, Proc. I.R.E., 40, p.1098 (1952)”.

Methods of distributing content software are known in which, for example, audio signals encoded as described above are encrypted and broadcast or recorded on a recording medium so that only a person that purchases a key will be allowed to enjoy the content. For example, in a known method of encryption, a seed for a random number sequence is assigned as a key signal to a bit sequence of PCM (pulse code modulated) audio signal, the bit sequence is exclusive-ORed with a random number sequence of 0s and 1s generated from the seed, and a bit sequence thus generated is transmitted or recorded on a recording medium. According to this method, only a person that has obtained the key signal is allowed to play the audio signal correctly, while a person without the key signal is only allowed to hear noise. Obviously, more complex encryption methods may be used.

According to these scrambling methods, however, only noise is played if the key is not available or if an ordinary player is used, not allowing content of software to be grasped. Thus, for example, it has not been possible to distribute a disk having recorded thereon music in a relatively low quality and to allow a person to play the music in high quality by purchasing a key or to newly purchase a disk having recorded thereon the music in high quality if the person likes the music as a result of previewing.

Also, when an efficiently encoded signal is encrypted, it has been difficult to provide a meaningful code string to an ordinary player while avoiding reduction in compression rate. That is, when an efficiently encoded code string is scrambled, only noise is played from the code string. Furthermore, if the scramble code string is not compatible with a standard for the original efficiently encoded code string, it is even possible that the player does not work at all. On the other hand, if a PCM signal is scrambled and then efficiently encoded, for example, if the amount of information is reduced based on characteristics of auditory perception, the scrambled PCM signal is not necessarily reproduced, inhibiting correct descrambling. Accordingly, it has been necessary to select a compression method that allows correct descrambling even if efficiency of compression is reduced.

In view of the above, Japanese Laid-Open Application No. Hei 10-135944, or U.S. Pat. No. 6,081,784, proposed earlier by the inventors of the present invention, discloses an audio encoding method that allows previewing of a narrow-band signal even without a key by, for example, transforming a music signal into a spectrum signal, encoding the spectrum signal, and encrypting only a higher range of the encoded signal. More specifically, according to the method, the higher range is encrypted and bit allocation information, etc. of the higher range is replaced with dummy data while recording real bit allocation information of the higher range at a position that is to be neglected by an ordinary decoder. This method allows a user to enjoy music in high quality only if the user likes the music as a result of previewing.

In the method of Japanese Laid-Open Application No. Hei 10-135944, or U.S. Pat. No. 6,081,784, however, security of data depends only on encryption. Thus, in case of encryption being broken, high-quality music could be distributed without collecting charge.

### SUMMARY OF THE INVENTION

The present invention has been made in view of the above, and it is an object of the present invention to provide a signal processing method and apparatus and a code string generating method and apparatus in which a signal is encrypted only partially so as to allow previewing while reducing the risk of illegitimate decoding of the signal, and that allow the signal to be played or recorded in high quality only by adding a relatively small amount of additional data that can be readily handled and processed to the signal supplied for previewing.

According to the present invention, dummy data is used for part of information in a code string obtained by encoding a content signal so that the content signal can be played in a relatively low quality by providing a code string for previewing (a first code string), and when the content signal is wished to be played in high quality, the dummy data is rewritten with real data (a second code string). Accordingly, the risk of illegitimate decoding of the content signal is reduced, and the content signal can be played by a normal playing apparatus whether the content signal is recorded on a recording medium either in low quality or in high quality. For example, by changing the amount of dummy data for spectrum components in a lower part of a range above a predetermined frequency, the amount of one frame of the additional data string (the second code string) serving as the real data is fixed or varied so as to be an integer multiple of an encryption unit. Accordingly, the process of combining the data string for previewing (the first code string) and the additional data string (the second code string) is facilitated, and cost of the combining process is reduced when the combining process is implemented in hardware.

According to one aspect of the present invention, in a signal processing method or a signal processing apparatus for playing or recording a code string obtained by encoding a signal on a frame-by-frame basis, a first code string in which the code string is partially replaced with dummy data is input, a second code string is input, a predetermined process is executed on each unit of a predetermined amount of data of the second code string, the dummy data in the first code string is rewritten with the second code string to replace the dummy data; and a decoding step of decoding the rewritten code string, and, in the second code string, an amount of data relating to or associated with one frame of the original code string is an integer multiple of the predetermined amount of data.

Accordingly, the first and second code strings are combined while reducing the load of the predetermined process on the second code string. Thus, for example, the present invention serves to implement a system as follows.

In the system according to the present invention, enhancement data for replacing dummy data in a first code string in order to play content in high quality is used as a, second code string, and data in low quality or common quality such that a user is allowed to check content is used as the first code string. Accordingly, the system allows the user to determine whether to obtain information required for playing content of software in high quality after checking it. Thus, for example, the present invention serves to implement a system that allows more smooth distribution of software compared with before. Furthermore, if a decryption process is used as the predetermined process, the amount of data of the second code string becomes an integer multiple of a decryption unit of the decryption process, so that the process of combining data string for previewing and additional data string is facilitated. Accordingly, when high-quality playing in the system is implemented in hardware, the combining process can be implemented at a lower cost.

According to another aspect of the present invention, in a code string generating method or a code string generating apparatus, an input signal is encoded to generate a code string in a predetermined format, part of the code string in the predetermined format is rewritten with dummy data to generate a first code string, and a second code string including the part of the code string in the predetermined format, having been replaced with the dummy data, is generated, and, in the second code string, an amount of data relating to or associated with one frame of the original code string is an integer multiple of the predetermined amount of data.

The amount of data of one frame of the second code string may be fixed. Preferably, an encryption process is performed on the second code string, the predetermined process is a decryption process of decrypting the encrypted second code string, and the predetermined amount of data is an encryption unit of the encryption process or a decryption unit of the decryption process.

For example, an input signal is spectral-transformed and split into bands, generating a code string in a predetermined format including quantization precision information, normalization coefficient information, and spectrum coefficient information for each of the bands, and the dummy data includes dummy data for part of at least one of the quantization precision information, the normalization coefficient information, and the spectrum coefficient information. Dummy data for the spectrum coefficient information is preferably encoded using variable-length codes. The dummy data includes, for example, dummy data for normalization coefficient information of a tone spectrum component.

Accordingly, data can be correctly decoded and played only when a matching pair of first code string and second code string is obtained. Furthermore, data string for previewing and additional data string can be readily combined, so that the combining process can be implemented at a lower cost when implemented in hardware.

### BRIEF DESCRIPTION OF THE DRAWINGS

FIG. 1 is a block diagram showing a schematic construction of an optical disk recording/playing apparatus that serves to explain an embodiment of the present invention;

FIG. 2 is a block diagram showing a schematic construction of an example of an encoding apparatus that serves to explain an embodiment of the present invention;

FIG. 3 is a block diagram showing an example of a transform unit of the encoding apparatus shown in FIG. 2;

FIG. 4 is a block diagram showing an example of a signal component encoding unit of the encoding apparatus shown in FIG. 2;

FIG. 5 is a block diagram showing a schematic construction of an example of a decoding apparatus that serves to explain an embodiment of the present invention;

FIG. 6 is a block diagram showing an example of an inverse transform unit of the decoding apparatus shown in FIG. 5;

FIG. 7 is a block diagram showing an example of a signal component decoding unit of the decoding apparatus shown in FIG. 5;

FIG. 8 is a diagram for explaining an encoding method that serves to explain an embodiment of the present invention;

FIG. 9 is a diagram for explaining part of a code string obtained by an encoding method that serves to explain an embodiment of the present invention;

FIG. 10 is a diagram for explaining another example of encoding method that serves to explain an embodiment of the present invention;

FIG. 11 is a block diagram showing an example of a signal component encoding unit for implementing the encoding method relevant to FIG. 10;

FIG. 12 is a block diagram showing an example of a signal component decoding unit of a decoding apparatus for decoding a code string obtained by the encoding method relevant to FIG. 10;

FIG. 13 is a diagram showing an example of a code string obtained by the encoding method relevant to FIG. 10;

FIG. 14 is a diagram showing an example of a code string obtained by an encoding method used in an embodiment of the present invention;

FIG. 15 is a diagram showing an example of a spectrum of a playing signal of a code string obtained by the encoding method relevant to FIG. 14;

FIG. 16 is a diagram showing an example of a spectrum of a playing signal of a code string obtained by another example of an encoding method relevant to FIG. 14;

FIG. 17 is a diagram showing a schematic construction of a playing apparatus for implementing the encoding method relevant to FIG. 15;

FIG. 18 is a diagram showing an example of information for replacing dummy data in a code string obtained by the encoding method relevant to FIG. 15;

FIG. 19 is a block diagram showing a schematic construction of a recording apparatus that is used in an embodiment of the present invention;

FIG. 20 is an example of information for replacing dummy data in a code string obtained by an encoding method used in an embodiment of the present invention;

FIG. 21 is a flowchart for explaining a playing method used in an embodiment of the present invention;

FIG. 22 is a flowchart for explaining a recording method used in an embodiment of the present invention;

FIG. 23 is a diagram showing an example of a code string obtained by another encoding method used in an embodiment of the present invention;

FIG. 24 is a block diagram showing an example of a code string generating apparatus according to an embodiment of the present invention;

FIG. 25 is a flowchart showing operation of the code string generating apparatus according to the embodiment of the present invention;

FIG. 26 is a flowchart for explaining a process of calculating the amount of dummy data in a mid-range spectrum in the code string generating apparatus according to the embodiment of the present invention;

FIG. 27 is a block diagram showing an example of a playing apparatus according to an embodiment of the present invention;

FIG. 28 is a block diagram showing an example of a recording apparatus according to an embodiment of the present invention; and

FIG. 29 is a flowchart for explaining a rewriting process of rewriting real data to enhance quality in an embodiment of the present invention.

### DESCRIPTION OF THE PREFERRED EMBODIMENTS

Before describing preferred embodiments of the present invention, an optical disk recording/playing apparatus that functions as a common compressed data recording/playing apparatus, which serves to describe the embodiments, will be described with reference to the accompanying drawings.

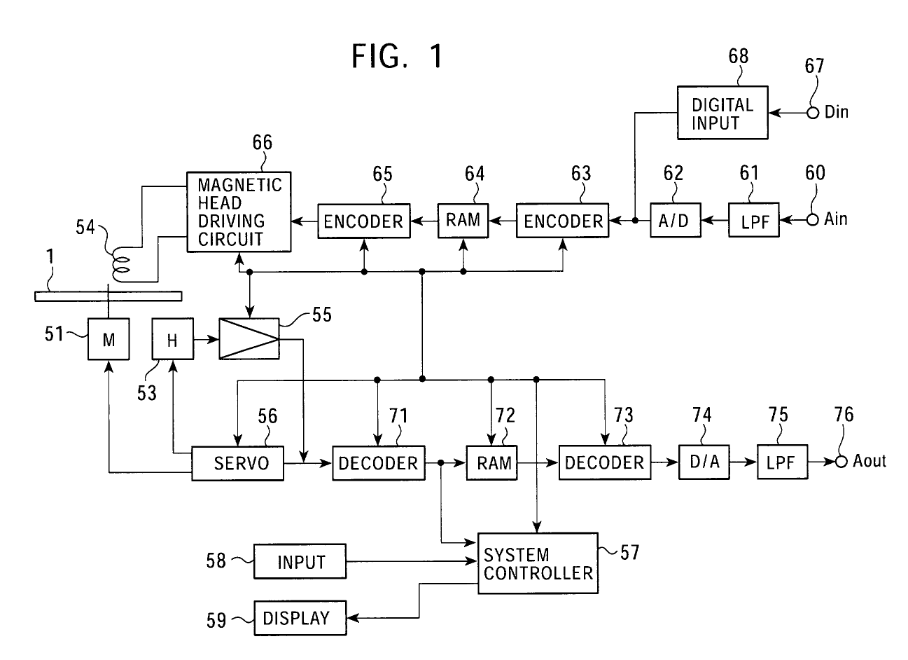

FIG. 1 is a block diagram showing an example of an optical disk recording/playing apparatus. In the apparatus shown in FIG. 1, a magneto-optical disk 1, driven by a spindle motor 51 to rotate, is used as a recording medium. When data is recorded on the magneto-optical disk 1, for example, a magnetic field modulated according to recording data is applied by a magnetic head 54 while radiating a laser beam by an optical head 53, that is, what is called magnetic field modulation recording is performed, whereby the data is recorded along a recording track of the magneto-optical disk 1. When data is played, a recording track of the magneto-optical disk 1 is traced with a laser beam by the optical head 53, thereby magneto-optically playing the data.

The optical head 53 includes, for example, a laser beam source such as a laser diode, optical components such as a collimator lens, an object lens, a polarization beam splitter, and a cylindrical lens, and a photodetector having a predetermined pattern of photoreceptor. The optical head 53 is disposed so as to oppose the magnetic head 54 across the magneto-optical disk 1. When data is recorded on the magneto-optical disk 1, the magnetic head 54 is driven by a head driving circuit 66 of a recording system, which will be described later, thereby applying a magnetic field modulated according to the recording data, and a target track of the magneto-optical disk 1 is irradiated with a laser beam by the optical head 53, thereby thermo-magnetically recording the data based on magnetic field modulation. Furthermore, the optical head 53 detects reflection of the laser beam incident on the target track, thereby detecting a focus error by, for example, what is called an astigmatic method, and detecting a tracking error by, for example, what is called a push-pull method. When the data is played from the magneto-optical disk 1, the optical head 53 detects the focus error and the tracking error and also detects difference in polarization angle (Kerr rotation angle) of a reflection of a laser beam from the target track, thereby generating a playing signal.

The output of the optical head 53 is supplied to an RF circuit 55. The RF circuit 55 extracts the focus error signal and the tracking error signal from the output of the optical head 53 and supplies these signals to a servo control circuit 56, and binarizes the playing signal and supplies the result to a decoder 71 of a playing system, which will be described later.

The servo control circuit 56 includes, for example, a focus servo control circuit, a tracking servo control circuit, a spindle motor servo control circuit, and a sled servo control circuit. The focus servo control circuit controls focus of an optical system of the optical head 53 so that the focus error signal will be zero. The tracking servo control circuit controls tracking of the optical system of the optical head 53 so that the tracking error signal will be zero. The spindle motor servo control circuit controls the spindle motor 51 so that the magneto-optical disk 1 will be driven to rotate at a predetermined rotation rate (e.g., constant line velocity). The sled servo control circuit moves the optical head 53 and the magnetic head 54 to a target track position of the magneto-optical disk 1 as specified by a system controller 57. The servo control circuit 56, which executes the various control operations described above, sends information indicating operation status of each of the units under its control to the system controller 57.

The system controller 57 is connected to a key input operation unit 58 and to a display unit 59. The system controller 57 controls the recording system and the playing system based on operation input information from the key input operation unit 58. Furthermore, based on sector address information, obtained from a recording track of the magneto-optical disk 1 in accordance with header time and sub-code Q data, the system controller 57 controls recording position or playing position on the recording track being traced by the optical head 53 and the magnetic head 54. Furthermore, the system controller 57 executes control to display a playing time on the display unit 59 based on a data compression rate of the compression data recording/playing apparatus and playing position information on the recording track.

More specifically, regarding the display of playing time, the sector address information (absolute time information), obtained from the recording track of the magneto-optical disk 1 in accordance with header time and sub-code Q data, is multiplied by the reciprocal of the data compression rate (e.g., the reciprocal is four if the compression rate is ¼) to obtain actual time information, and the actual time information is displayed on the display unit 59. Also, when data is recorded, for example, if absolute time information is recorded in advance (preformatted) on a recording track of a magneto-optical disk or the like, it is possible to display a current position in terms of actual recording time by multiplying the preformatted absolute time information by the reciprocal of the data compression rate.

In the recording system of the optical disk recording/playing apparatus shown in FIG. 1, an analog audio input signal A_{IN} from an input terminal 60 is supplied to an A/D converter 62 via a low-pass filter 61, and the A/D converter 62 quantizes the analog audio input signal A_{IN}. A digital audio signal yielded by the A/D converter 62 is supplied to an ATC (adaptive transform coding) encoder 63. Also, a digital audio input signal D_{IN} from an input terminal 67 is supplied to the ATC encoder 63 via a digital input interface circuit 68. The ATC encoder 63 executes bit compression (data compression) of digital audio PCM data supplied at a predetermined transfer rate, yielded by quantizing the input signal A_{IN} by the A/D converter 62, by a predetermined data compression rate. The compressed data (ATC data) output from the ATC encoder 63 is supplied to a memory (RAM) 64. For example, if the data compression rate is ⅛, the data transfer rate is reduced to 1/8 (9.375 sectors/sec) of the data transfer rate (75 sectors/sec) of what is called the CD-DA format, which is the standard format of digital audio CD.

The memory (RAM) 64 is controlled by the system controller 57 so that data can be written thereto and read therefrom. The memory 64 is used as a buffer memory for temporarily storing the ATC data supplied from the ATC encoder 63 and recording the data on a disk as required. For example, if the data compression rate is ⅛, the data transfer rate of the compressed audio data supplied from the ATC encoder 63 is reduced to ⅛ of the data transfer rate (75 sectors/sec) of the standard CD-DA format, i.e., reduced to 9.375 sectors/sec, and the compressed data is continuously written to the memory 64. Although recording on one sector suffices for the compressed data (ATC data) for each set of eight sectors, since it is substantially impossible to record every eighth sector, sectors are continuously recorded as will be described later.

The recording is performed in bursts, with intervals, by units of cluster consisting of a predetermined number of sectors (e.g., 32 sectors+several sectors), at the same data transfer rate (75 sectors/sec) as that of the standard CD-DA format. That is, from the memory 64, ATC audio data with a data compression rate of ⅛, which has been continuously written at a low transfer rate of 9.375 (=75/8) sectors/sec in accordance with the bit compression rate, is read in bursts at a transfer rate of 75 sectors/sec as recording data. The overall data transfer rate of the recording data, with consideration of recording intervals, is the low transfer rate of 9.375 sectors/sec; however, the instantaneous data transfer rate in the burst recording operation is the standard 75 sectors/sec. Thus, if the rotation rate of the disk is the same as that of the standard CD-DA format (constant line velocity), recording is performed with the same recording density and recording pattern as in the case of the CD-DA format.

The ATC audio data, i.e., the recording data, which has been read in bursts at the (instantaneous) transfer rate of 75 sectors/sec from the memory 64, is supplied to an encoder 65. In the data sequence supplied from the memory 64 to the encoder 65, the unit of recording that is continuously recorded in a single recording period consists of a cluster having a plurality of sectors (e.g., 32 sectors) and several sectors for cluster connection disposed before and after the cluster. The length of the sectors for cluster connection is made longer than an interleaving length of the encoder 65 so that data of other clusters will not be affected even if interleaving is used.

The encoder 65 executes error correction coding (addition of parity and interleaving) and EFM (eight-to-fourteen modulation) coding on the recording data supplied in bursts from the memory 64 as described above. The recording data encoded by the encoder 65 is supplied to the magnetic head driving circuit 66. The magnetic head driving circuit 66 is connected to the magnetic head 54, and it drives the magnetic head 54 so that a magnetic field modulated according to the recording data will be applied to the magneto-optical disk 1.

The system controller 57 controls the memory 64 as described above, and controls recording position so that the recoding data read in bursts from the memory 64 as controlled will be continuously recoded on a recording track of the magneto-optical disk 1. More specifically, the system controller 57 controls recording position of the recording data read in bursts from the memory 64, and supplies a control signal specifying a recording position on a recording track of the magneto-optical disk 1 to the servo control circuit 56.

Next, the playing system of the optical disk recording/playing apparatus shown in FIG. 1 will be described. The playing system plays recording data continuously recorded on a recording track of the magneto-optical disk 1 by the recording system described above. The playing system includes a decoder 71, to which playing output obtained by tracing the recording track of the magneto-optical disk 1 with a laser beam by the optical head 53 and binarized by the RF circuit 55 is supplied. The playing system allows reading of read-only optical disks such as CDs (compact disks), and optical disks of the CD-R type, as well as magneto-optical disks.

The decoder 71 is a counterpart of the encoder 65 in the recording system described earlier. The decoder 71 executes error correction decoding and EFM decoding on the playing output binarized by the RF circuit 55, and plays the ATC audio data with a data compression rate of ⅛ at a transfer rate of 75 sectors/sec, which is faster than the normal transfer rate. The playing data obtained by the decoder 71 is supplied to a memory (RAM) 72.

The memory (RAM) 72 is controlled by the system controller 57 so that data can be written thereto and read therefrom. In the memory 72, the playing data supplied from the decoder 71 at the transfer rate of 75 sectors/sec is written in bursts at the same transfer rate of 75 sectors/sec. Also, from the memory 72, the playing data written in bursts at the transfer rate of 75 sectors/sec is continuously read at a transfer rate of 9.375 sectors/sec in accordance with the data compression rate of ⅛.

The system controller 57 controls the memory 72 so that the playing data will be written thereto at a transfer rate of 75 sectors/sec and so that the playing data will be continuously read therefrom at a transfer rate of 9.375 sectors/sec. In addition to controlling the memory 72, the system controller 57 controls playing position so that the playing data written in bursts to the memory 72 as controlled will be continuously played from the recording track of the magneto-optical disk 1. The system controller 57 controls playing position by managing a playing position of the playing data continuously read from the memory 72 and supplying a control signal specifying the playing position on the recording track of the magneto-optical disk 1 or an optical disk 1 to the servo control circuit 56.

The ATC audio data, i.e., the playing data continuously read from the memory 72 at the transfer rate of 9.375 sectors/sec, is supplied to an ATC decoder 73. The ATC decoder 73 is a counterpart of the ATC encoder 63 in the recording system, and it executes data expansion (bit expansion) of the ATC data, for example, eightfold expansion, to play digital audio data with sixteen bits. The digital audio data from the ATC decoder 73 is supplied to a D/A converter 74.

The D/A converter 74 converts the digital audio data supplied from the ATC decoder 73 into an analog signal, forming an analog audio output signal A_{OUT}. The analog audio signal A_{OUT} yielded by the D/A converter 74 is output from an output terminal 76 via a low-pass filter 75.

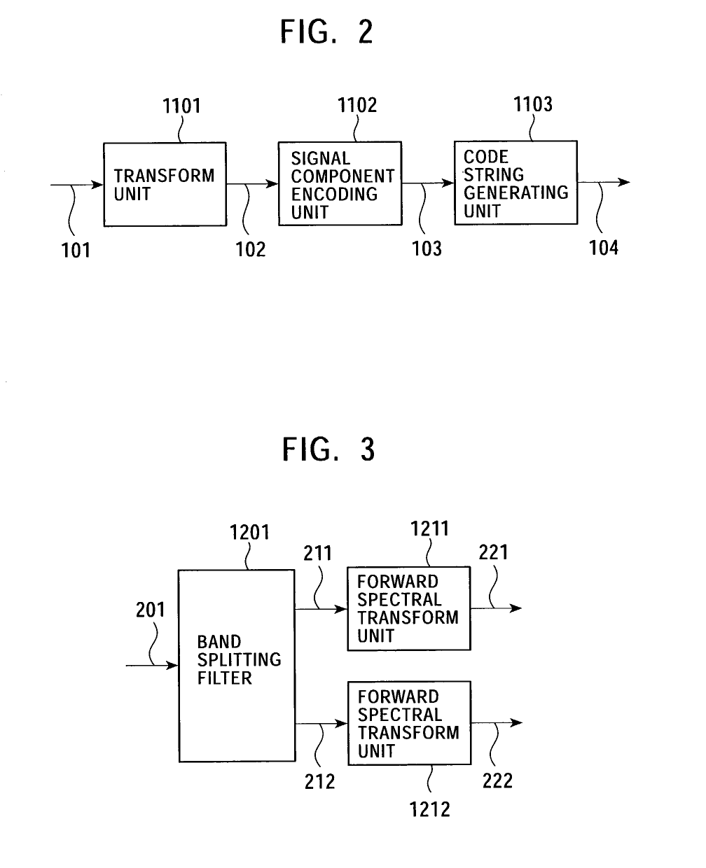

Next, efficient compression coding of signals will be described. More specifically, efficient coding of input digital signals such as audio PCM signals using sub-band coding (SBC), adaptive transform coding (ATC), and adaptive bit allocation will be described with reference to FIG. 2 and subsequent figures.

FIG. 2 is a block diagram showing an example of acoustic waveform signal encoding apparatus that serves to explain an embodiment of the present invention. In this example, an input signal waveform 101 is transformed into frequency component signals 102 by a transform unit 1101, the frequency component signals 102 are encoded by a signal component encoding unit 1102 to yield signals 103, and a code string 104 is generated from the signals 103 by a code string generating unit 1103.

FIG. 3 shows an example of the transform unit 1101 shown in FIG. 2. Referring to FIG. 3, a signal 201 is split by a band splitting filter 1201, yielding signals 211 and 212, and the signals 211 and 212 are transformed into spectrum signal components 221 and 222 in the respective bands by forward spectrum transform units 1211 and 1212, for example, based on MDCT. The signal 201 in FIG. 3 corresponds to the signal 101 in FIG. 1, and the signals 221 and 222 in FIG. 3 correspond to the signals 102 in FIG. 2. In the transform unit shown in FIG. 3, the bandwidth of each of the signals 211 and 212 is reduced to one half that of the signal 201; that is, each of the signals 211 and 212 is decimated to one half of the signal 201. Various implementations of the transform unit other than the above are also possible; for example, an input signal may be directly transformed into spectrum signals by MDCT, or an input signal may be transformed by DFT (discrete Fourier transform) or DCT (discrete cosine transform) instead of MDCT. Although it is also possible to split a signal into band components by what is called a band splitting filter, the above method of spectrum conversion is advantageous since it allows a large number of frequency components to be calculated with a relatively small amount of computation.

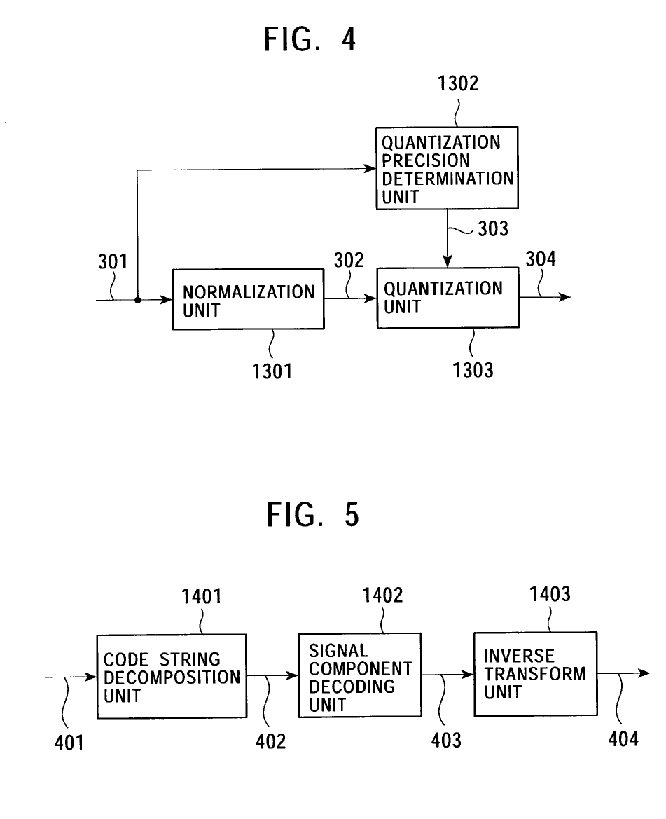

FIG. 4 shows an example of the signal component encoding unit 1102. Referring to FIG. 4, input signals 301 are normalized by a normalization unit 1301 on a predetermined band-by-band basis, yielding signals 302. The signals 302 are quantized by a quantization unit 1303 based on quantization precision information 303 calculated by a quantization precision determination unit 1302, yielding signals 304. The signals 301 in FIG. 4 correspond to the signals 102 in FIG. 2, and the signals 304 in FIG. 4 correspond to the signals 103 in FIG. 2. The signals 304 include normalization coefficient information and quantization precision information in addition to quantized signal components.

FIG. 5 is a block diagram showing an example of decoding apparatus for outputting an acoustic signal from a code string generated by the encoding apparatus shown in FIG. 2. In this example, a code string 401 is decomposed into signal component codes 402 by a code string decomposition unit 1401, the signal component codes 402 are decoded into signal components 403 by a signal component decoding unit 1402, and the signal components 403 are inversely transformed by an inverse transform unit 1403 to yield an acoustic waveform signal 404.

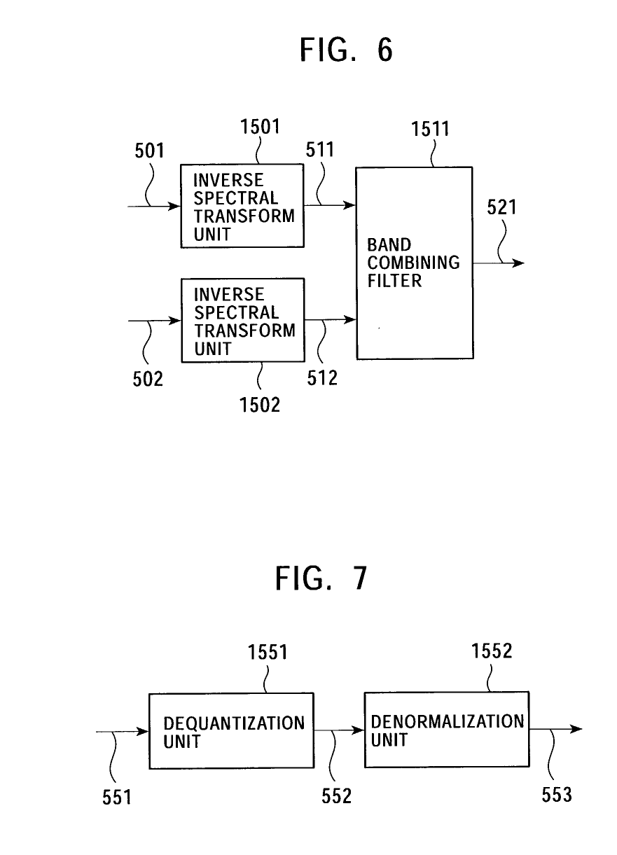

FIG. 6 shows an example of the inverse transform unit 1403 shown in FIG. 5, which is a counterpart of the example of the transform unit shown in FIG. 3. Referring to FIG. 6, signals 501 and 502 are inversely transformed by inverse spectrum transform units 1501 and 1502, yielding signals 511 and 512 in the respective bands, and the signals 511 and 512 are combined by a band combining filter 1511, yielding a signal 521. The signals 501 and 502 in FIG. 6 correspond to the signals 403 in FIG. 5, and the signal 521 in FIG. 6 corresponds to the signal 404 is FIG. 5.

FIG. 7 shows an example of the signal component decoding unit 1402 shown in FIG. 5. Signals 551 in FIG. 7 correspond to the signals 402 in FIG. 5, and signals 553 in FIG. 7 correspond to the signals 403 in FIG. 5. Referring to FIG. 7, the spectrum signals 551 are dequantized by a dequantization unit 1551, yielding signals 552, and the signals 552 are denormalized by a denormalization unit 1552, yielding the signals 553.

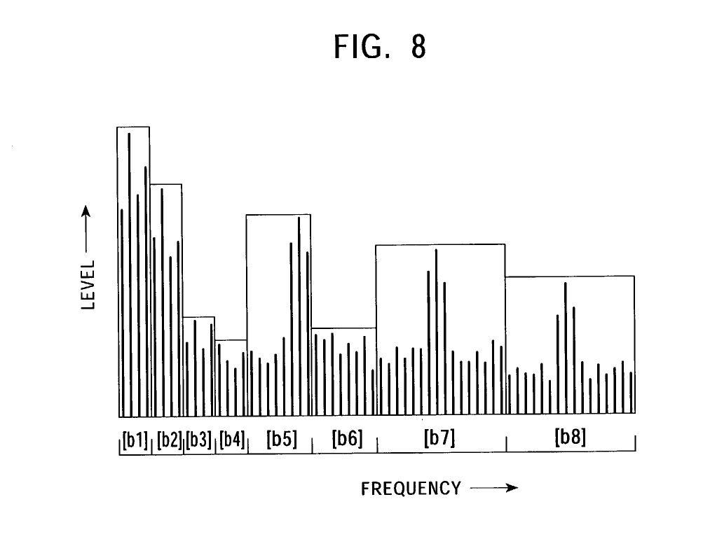

FIG. 8 is a diagram for explaining a conventional encoding method that has been employed in the encoding apparatus shown in FIG. 2. In this example, spectrum signals have been obtained based on MDCT by the transform unit shown in FIG. 3, and FIG. 8 shows the spectrum components as converted from absolute values into dB values. Referring to FIG. 8, an input signal is transformed into, for example, 64 spectrum signals in each predetermined time block, and the spectrum signals are grouped into eight bands b1 to b8 (hereinafter referred to as coding units) for normalization and quantization. Quantization precision is varied among the coding units depending on distribution of frequency components, allowing efficient audio coding with minimal degradation in sound quality.

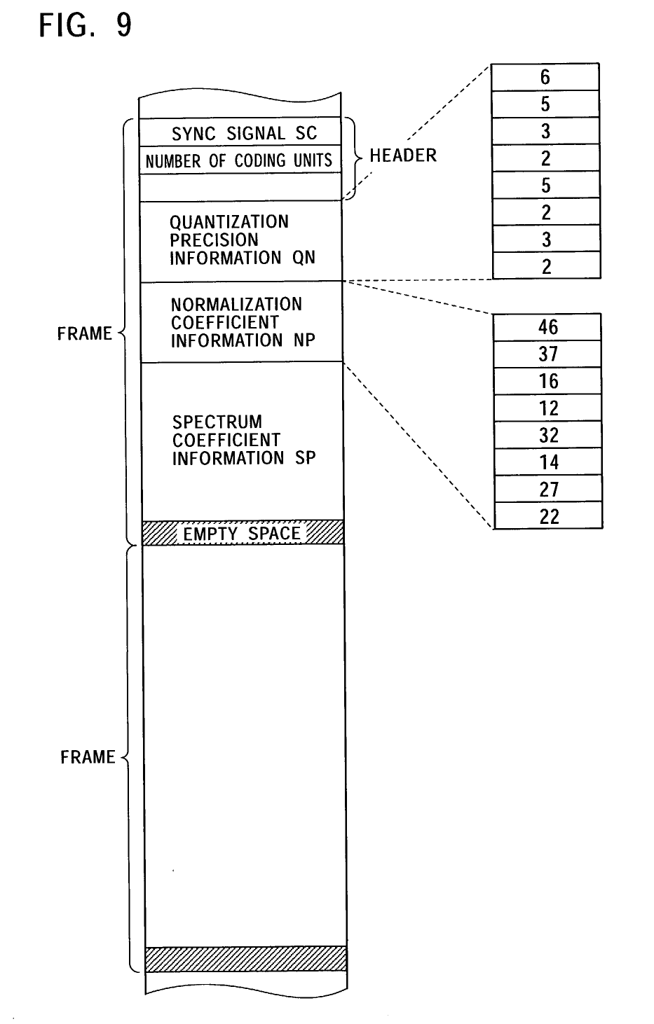

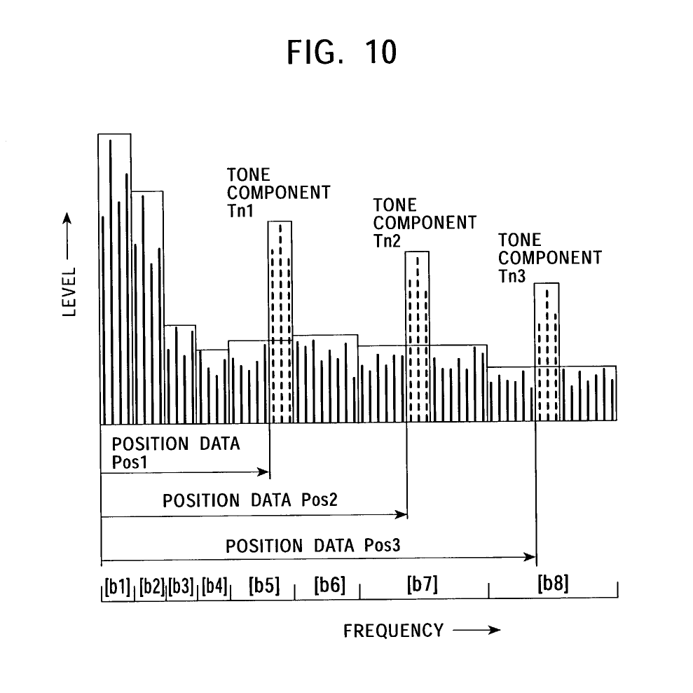

FIG. 9 shows an example of recording the signals encoded as described above on a recording medium. In this example, a header of a fixed length, including a sync signal SC, is attached at the beginning of each frame, and the number of coding units UN is recorded in the header. The header is followed by as many pieces of quantization precision information QN as the number of coding units. The quantization precision information QN is followed by as many pieces of normalization coefficient information NP as the number of coding units. The normalization coefficient information NP is followed by spectrum coefficient information SP that has been normalized and quantized. If the frame length is fixed, an empty space is allowed to exist after the spectrum coefficient information SP. This example deals with encoding of the spectrum signals shown in FIG. 8. In the example shown in FIG. 9, the quantization precision information QN is assigned, as shown, from six bits for the coding unit of the lowest band to two bits for the coding unit of the highest band, and the normalization coefficient information NP is assigned, as shown, from 46 for the coding unit of the lowest band to 22 for the coding unit of the highest band. The values of the normalization coefficient information NP are chosen, for example, so as to be proportional to values in dB.

Coding efficiency of the method described above can be further improved. For example, coding efficiency can be improved by assigning relatively short codes to quantized spectrum signals with high frequencies of occurrence while assigning relatively long codes to spectrum signals with low frequencies of occurrence. Also, coding efficiency can be improved by using transform blocks of a longer length to relatively reduce the amount of auxiliary information such as quantization precision information and normalization coefficient information, and to improve frequency resolution, allowing more specific control of quantization precision on the frequency axis.

Furthermore, the inventors have proposed earlier, in the description and drawings of Japanese Patent Application No. 5-152865, or WO94/28633, a method of separating a tone component that is particularly significant for auditory perception, i.e., a signal component around a particular frequency at which energy is concentrated, and encoding the tone component separately from other spectrum components. This allows audio signals, etc. to be efficiently encoded with a high compression rate without substantially degrading audible sound.

FIG. 10 is a diagram for explaining the encoding method mentioned above. In the example shown in FIG. 10, spectrum signals with particularly high levels, namely, tone components Tn1 to Tn3, are separated for encoding. The tone components Tn1 to Tn3 require position information, i.e., their respective position data Pos1 to Pos3. However, spectrum signals after the tone components Tn1 to Tn3 have been extracted can be quantized with a smaller number of bits. Thus, the above method is particularly efficient for encoding a signal in which energy is concentrated in particular spectrum signals.

FIG. 11 shows the construction of the signal component encoding unit 1102, shown in FIG. 2, for encoding tone components separately as described above. The output signals 102 (signals 601 in FIG. 11) from the transform unit 1101 shown in FIG. 2 are separated into tone components (signals 602) and non-tone components (signals 603) by a tone component separating unit 1601. The tone components and non-tone components are encoded by a tone component encoding unit 1602 and a non-tone component encoding unit 1603, yielding signals 604 and 605, respectively. The tone component encoding unit 1602 and the non-tone component encoding unit 1603 are constructed as shown in FIG. 4, and the tone component encoding unit 1602 also encodes position information of the tone components.

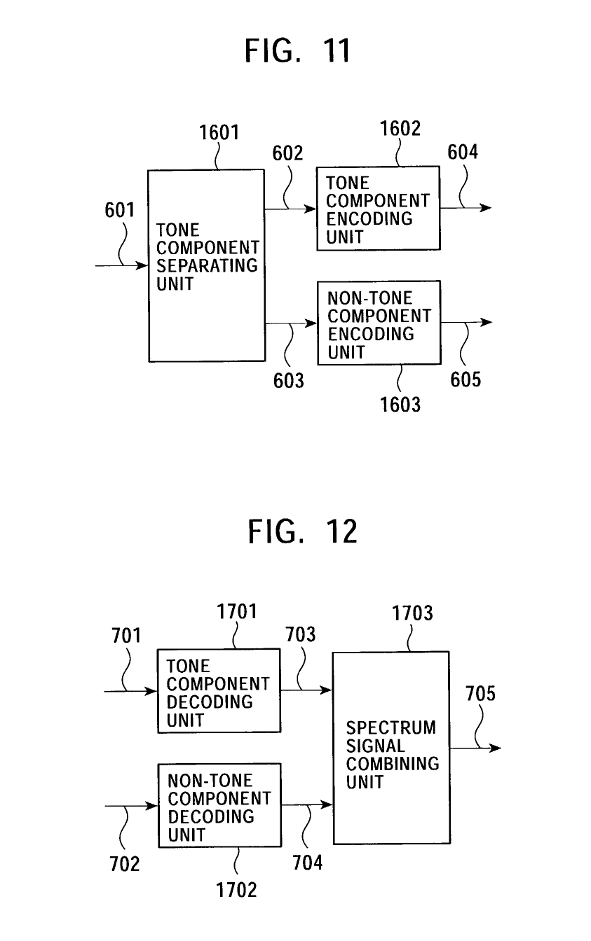

Similarly, FIG. 12 shows the construction of the signal component decoding unit 1402, shown in FIG. 5, for decoding tone components that have been encoded separately as described above. Signals 701 in FIG. 12 correspond to the signals 604 in FIG. 11, and signals 702 in FIG. 12 correspond to signals 605 in FIG. 11. The signals 701 are decoded by a tone component decoding unit 1701, yielding signals 703, and the signals 703 are transferred to a spectrum signal combining unit 1703. The signals 702 are decoded by a non-tone component decoding unit 1702, yielding signals 704, and the signals 704 are transferred to the spectrum signal combining unit 1703. The spectrum signal combining unit 1703 combines the tone components (signals 703) and non-tone components (signals 704), yielding signals 705.

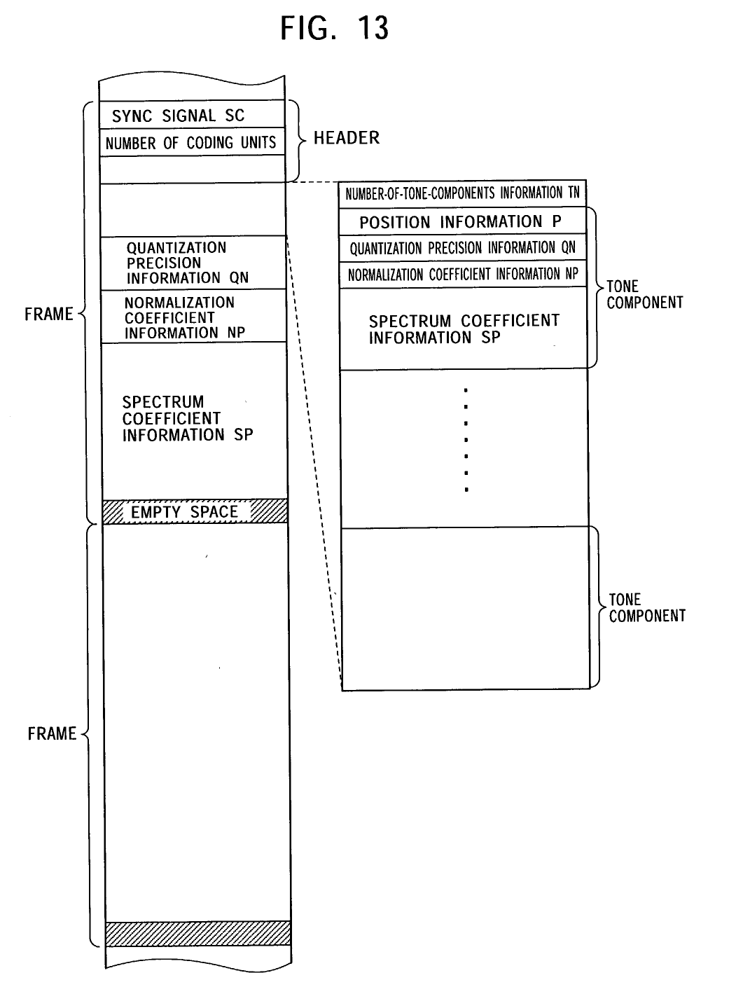

FIG. 13 shows an example of recording the signals encoded as described above on a recording medium. In this example, tone components are encoded separately, and a code string of the tone components is recorded between a header and quantization precision information QN. In the tone component code string, number-of-tone-components information TN is recorded first, followed by data of each of the tone components. Data of each of the tone components includes position information P, quantization precision information QN, normalization coefficient information NP, and spectrum coefficient information SP. In this example, compared with the example shown in FIG. 9, block length for spectral transform is doubled to improve frequency resolution, and variable-length codes are used. Thus, compared with the example shown in FIG. 9, a code string corresponding to an acoustic signal that is twice as long is recorded in a frame having-the same number of bytes.

The above description has dealt with technologies presupposed for description of embodiments of the present invention. In an embodiment of the present invention, for example, if applied to audio data, audio signals of a relatively low quality can be listened to freely as a sample, while audio signals of a high quality can be listened to by purchasing or otherwise obtaining a relatively small amount of additional data, the amount of one frame of the additional data being an integer multiple of a predetermined amount of data (e.g., an encryption unit).

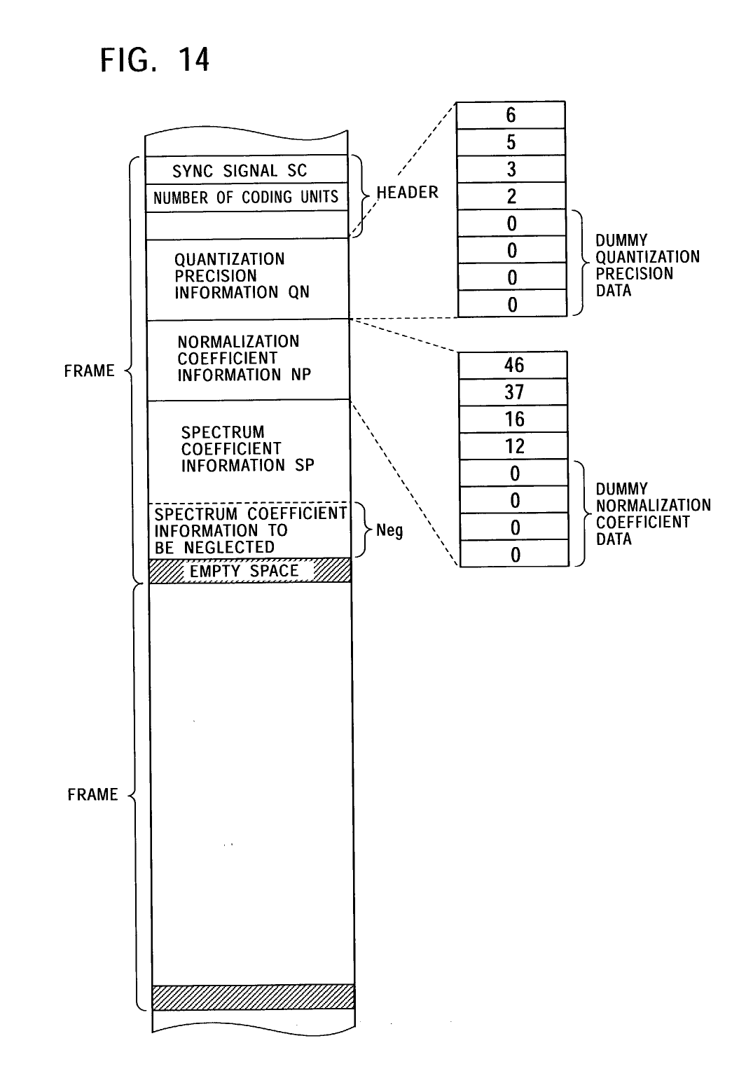

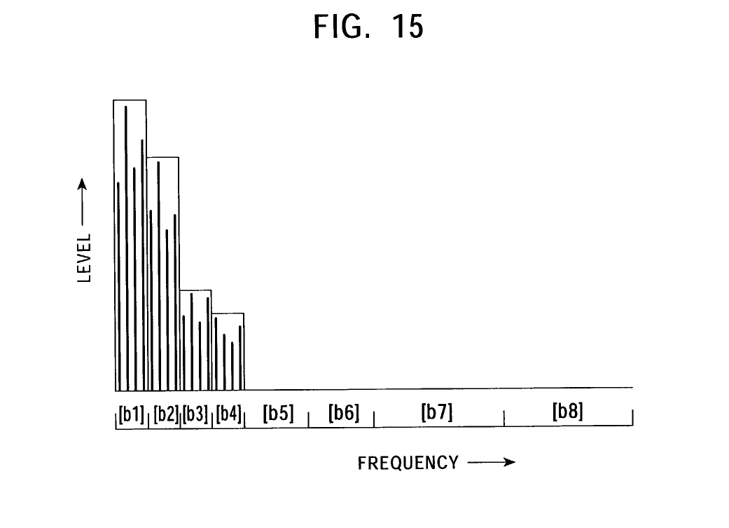

More specifically, in this embodiment, for example, instead of encoding as shown in FIG. 9, data indicating zero bit allocation is encoded for the higher four coding units as dummy quantization precision data in quantization precision information QN, as shown in FIG. 14. Also, normalization coefficient information with a minimum value of zero is encoded for the higher four coding units as dummy normalization coefficient information in normalization coefficient information NP. (The normalization coefficient is a value proportional to a dB value in this example.) As described above, by setting the quantization precision information to zero in the higher range, spectrum coefficient information in a region designated as Neg in FIG. 14 is actually neglected, and when the data is played by a normal playing apparatus, data of a narrow band having a spectrum as shown in FIG. 15 is played. Furthermore, by encoding dummy data for normalization coefficient information, it is further inhibited to infer quantization precision information and to illegitimately play the data in high quality.

In a signal playing apparatus and method used in the embodiment, when a code string obtained by encoding a signal on a frame-by-frame basis is played, a first code string, part of which is dummy data, is input, a second code string is input, a predetermined process is executed on each unit of a predetermined amount of data of the second code string, the dummy data in the first code string is rewritten with the second code string to replace the dummy data, and the rewritten code string is decoded, the amount of one frame of the second code string being an integer multiple of the predetermined amount of data.

In a signal recording apparatus and method according to the embodiment, when a code string obtained by encoding a signal on a frame-by-frame basis is recorded on a recording medium, a first code string, part of which is dummy data, is input, a second code string is input, a predetermined process is executed on each of a predetermined amount of data of the second code string, the dummy data in the first code string is rewritten with the second code string to replace the dummy data, and the rewritten code string is decoded, the amount of one frame of the second code string being an integer multiple of the predetermined amount of data.

For example, the second code string is encrypted, the predetermined process is a decryption process, and the predetermined amount of data is a decryption unit in the decryption process.

It is possible to replace quantization precision information and normalization coefficient information of all the bands with dummy data. In this case, no meaningful data can be played by a normal playing apparatus. In order to allow previewing, part of dummy data is rewritten with a partial code string in the second code string (e.g., quantization precision information and normalization coefficient information in a lower range). When playing in high quality is desired, quantization precision information and normalization coefficient information corresponding to the remaining part of the dummy data, i.e., code string of the remaining part other than the partial code string in the second code string is purchased or otherwise obtained as additional data, replacing the entire dummy data, thereby allowing playing in high quality (sound or picture quality). Furthermore, by changing the amount of the partial code string in the second code string, quality of signals for previewing can be changed arbitrarily.

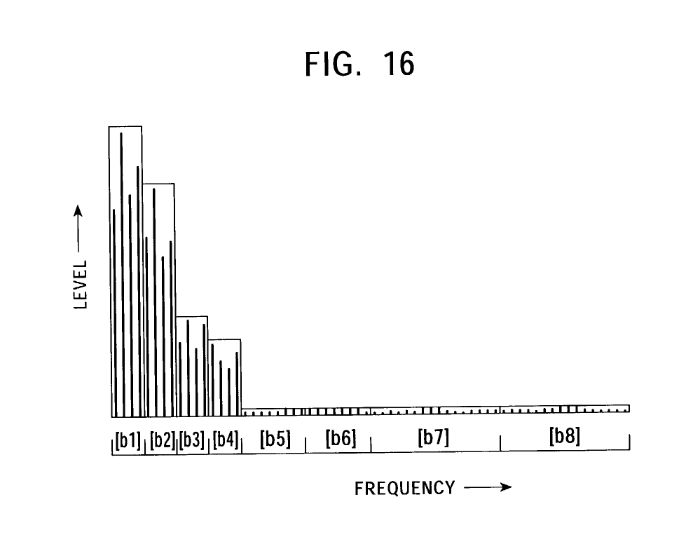

Although both quantization precision information and normalization coefficient information are replaced with dummy data in the above example, alternatively, only one of these may be replaced with dummy data. If dummy data is used only for quantization precision information (O bit data), data of a narrow band having a spectrum as shown in FIG. 15 is played. When dummy data is used only for normalization coefficient information (value of 0), a spectrum as shown in FIG. 16 is generated. In this case, although spectrum components in the higher range are not strictly zero, the components are substantially zero in terms of audibility. A signal having such a spectrum will also be referred to as a narrow band signal herein.

Depending on which of quantization precision information and normalization coefficient information dummy data is used for, risk of real values of the data being inferred and the real data being played in high quality differs. If dummy data is used for both quantization precision information and normalization coefficient information, maximum security is achieved since no data that allows the real values to be inferred is present. If dummy data is used only for quantization precision information, for example, if the algorithm for original bit allocation calculates quantization precision information based on normalization coefficient information, the risk is relatively high since the quantization precision information might be inferred using the normalization coefficient information. In contrast, it is relatively difficult to calculate normalization coefficient information from quantization precision information, so that the risk in using dummy data only for normalization coefficient information is lower compared to using dummy data only for quantization precision information. Furthermore, it is possible to use dummy data selectively for quantization precision information and normalization coefficient information on a band basis.

Furthermore, part of spectrum coefficient information may also be replaced with dummy data of 0s. In particular, the mid-range spectrum, which is significant for sound quality, may be replaced with dummy data of 0s while using dummy quantization precision information and dummy normalization coefficient information in the higher range. In that case, bands in which quantization precision information and normalization coefficient information are replaced with dummy data should include a band in which part of spectrum coefficient information is replaced with dummy data. Particularly, if variable-length coding is used for encoding spectrum coefficient information, part of information in the mid-range is lost, inhibiting decoding of data in the higher range.

In any case, it is more difficult to infer relatively large amount of data regarding content of signals than to cryptanalize a relatively short key used for ordinary encryption. Thus, for example, the risk of infringement of the copyright of the copyright holder of the song is reduced. Furthermore, even if dummy data of a song is inferred, as opposed to a case where the encryption algorithm is broken, damage does not propagate to other songs, so that security is higher than using a particular encryption algorithm.

That is, according to the embodiment described above, when a code string of a predetermined format obtained by encoding a signal is played, a first code string of the predetermined format, at least part of which is dummy data is input, and at least part of the dummy data is rewritten with a partial code string of a second code string to replace the dummy data, and the code string rewritten with the partial code string of the second code string is decoded. Accordingly, it is allowed to determine whether to obtain information required for playing in high quality after previewing content (software). In addition, as opposed to a case where encryption is used, the risk of illegitimate playing in high quality, for example, by cryptanalysis, is reduced, and content can be distributed more smoothly. Furthermore, quality (sound or picture quality) of signals for previewing can be arbitrarily changed by changing the partial code string of the second code string, for example, by changing bandwidth. Furthermore, by using a second code string of a fixed length for each frame or by varying the lengths of second code strings to be integer multiples of an encryption unit, the process of combining a first code string (data string for previewing) and a second code string (additional data string) is simplified, and relevant cost is reduced when the process is implemented in hardware.

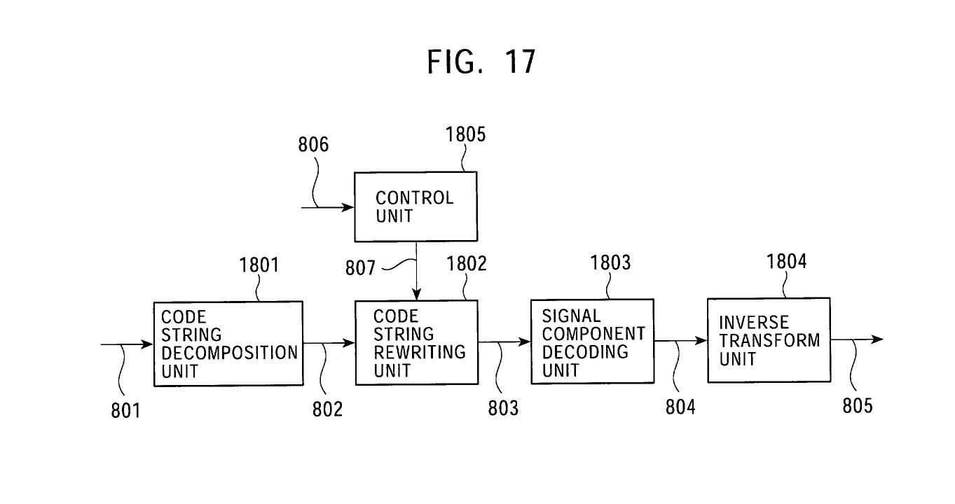

FIG. 17 is a block diagram showing an example of a playing apparatus that is used in an embodiment of the present invention, which is an improvement of the conventional decoding unit shown in FIG. 5.

Referring to FIG. 17, an input signal 801 is a code string (a first code string) that has partially been replaced with dummy data, and in this example, dummy data is used for quantization precision information and normalization coefficient information in all the bands or in the higher band and for spectrum coefficient information in the mid-range. The signal 801, efficiently encoded and including dummy data embedded therein, is received via a public network (e.g., ISDN (Integrated Services Digital Network), satellite link, analog network), and is input to a code string decomposition unit 1801. The code string decomposition unit 1801 decomposes the code string into signals 802, and the signals 802 are transferred to a code string rewriting unit 1802. The code string rewriting unit 1802 receives a signal 807 of a second code string for replacing the dummy data, including real quantization precision information, normalization coefficient information, and mid-range spectrum coefficient information 806, and rewrites the dummy quantization precision information, normalization coefficient information, and mid-range spectrum coefficient information in the signal 802 with the signal 807, yielding a signal 803, and the signal 803 is transferred to a signal component decoding unit 1803. The signal component decoding unit 1803 decodes the signal 803 into spectrum data 804, and an inverse transform unit 1804 transforms the spectrum data 804 into time-series data 805, whereby an audio signal is played.

In the construction shown in FIG. 17, in a purchase mode, real quantization precision information and/or real normalization coefficient information 806 for rewriting the dummy data therewith is input to a control unit 1805 via the same public network as for the signal 801. The control unit 1805 rewrites the dummy data in the efficiently encoded signal 801 input to the code string rewriting unit 1802 with the real quantization precision information and/or real normalization coefficient information 806, and the efficiently encoded signal 803 obtained by rewriting is input to the signal component decoding unit 1803.

Accordingly, in a preview mode, a user is allowed to listen to sample music in a low quality in which dummy data is added, while the user when allowed to listen to music in a high quality if a predetermined purchasing procedure (billing, authentication, etc.) has been executed.

The above description has been made in the context of an example in which all the dummy data is rewritten (replaced) with the second code string. However, without limitation thereto, part of the dummy data may be rewritten with a partial code string of the second code string. When at least part of the dummy data is rewritten with a partial code string of the second code string as described above, quality (sound quality, picture quality, etc.) of preview data can be arbitrarily changed by arbitrarily changing the ratio of the partial code string to the second code string.

If the encoding method is such that a content signal is spectral-transformed, spectrum signals are split into bands, and a code string in a predetermined format including quantization precision information, normalization coefficient information, and spectrum coefficient information for each of the bands is generated, the dummy data corresponds to at least part of at least one of the quantization precision information, the normalization coefficient information, and the spectrum coefficient information, and in this example, the partial code string of the second code string corresponds to information in the lower range of the dummy data. More specifically, for example, if the dummy data corresponds to quantization precision information in the higher range or normalization coefficient information in the higher range, the partial code string of the second code string corresponds to quantization precision information or normalization coefficient information in the lower range.

If data (the partial code string of the second code string) for replacing the dummy data is for all the bands or substantially all the bands of information corresponding to the dummy data, an audio signal in high quality, having a large bandwidth, is played. If the data (the partial code string of the second data) for replacing the dummy data is for a partial narrow band of information corresponding to the dummy data, an audio signal having a narrow bandwidth is played. Thus, quality of preview data can be controlled according to the corresponding bandwidth of the data for replacing the dummy data, and an audio signal having a large bandwidth can be played.

In the embodiment described above, the efficiently encoded signal 801 including dummy data embedded therein and the real quantization precision information and/or real normalization coefficient information (the second code string or a partial code string thereof) 806 for rewriting the dummy data therewith are obtained from a server via the same public network. Alternatively, for example, the efficiently encoded signal 801 including the dummy data embedded therein, which is large in amount of data, may be obtained via a satellite link at a high transmission rate while separately obtaining the real quantization precision information and/or normalization coefficient information 806, which is small in amount of data, via a network having a relatively low transmission rate, such as a telephone network or ISDN. Yet alternatively, the signal 801 may be supplied using recording media having a large capacity, such as CD-ROMs or DVD (digital versatile disk)—ROMs. The above serves to enhance security.

With regard to tone components and non-tone components described with reference to FIG. 13, dummy data may be embedded in efficiently encoded signals of quantization precision information and/or normalization coefficient information for both tone components and non-tone components.

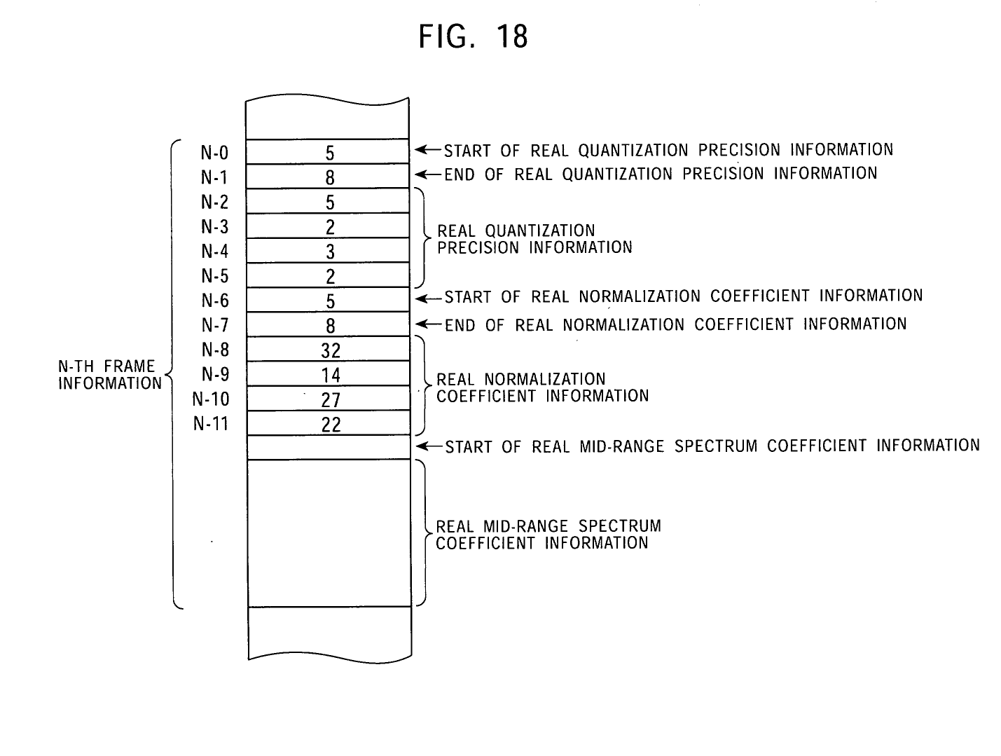

FIG. 18 shows an example format of real information (second code string) of the signal 807 from the control unit 1805 shown in FIG. 17, which serves to change information of N-th frame shown in FIG. 14 into information shown in FIG. 9. This changes a playing sound of a code string including dummy data from the spectrum shown in FIG. 15 to the spectrum shown in FIG. 8. It is assumed herein that the length of real mid-range spectrum coefficient information that is replaced with dummy data is fixed.

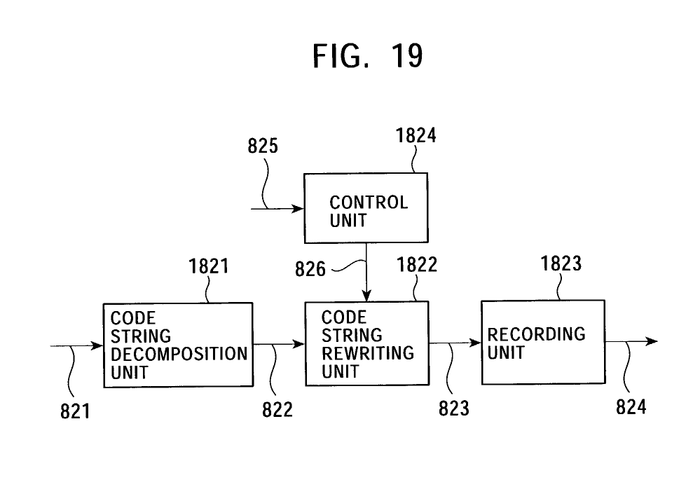

FIG. 19 is a block diagram showing an example of a recording apparatus that is used in an embodiment of the present invention. Referring to FIG. 19, an input signal 821 is a first code string that has been partially replaced with dummy data, and in this example, dummy data is used for quantization precision information and normalization coefficient information in the higher range and mid-range spectrum coefficient information. The input signal 821 is decomposed by a code string decomposition unit 1821 into signals 822, and the signals 822 are transferred to a code string rewriting unit 1822. The code string rewriting unit 1822 receives a signal 826 of a second code string including real quantization precision information, normalization coefficient information, and mid-range spectrum coefficient information 825, and rewrites dummy quantization precision information, normalization coefficient information, and mid-range spectrum coefficient information in the signal 822 with the signal 826, yielding a signal 823. The signal 823 is transferred to a recording unit 1823 and recorded on a recording medium. The recording medium for recording a code string of a signal 824 may be the recording media on which the code string of the signal 821 has been recorded.

In the embodiment shown in FIG. 19, similarly to the embodiment shown in FIG. 17, instead of rewriting (replacing) all the dummy data with the second code string, part of the dummy data may be rewritten with a partial code string of the second code string. When at least part of the dummy data is replaced with a partial code string of the second code string as described above, quality (sound quality, picture quality, etc.) of preview data can be arbitrarily changed by arbitrarily changing the ratio of the partial code string to the second code string. In that case, even in preview mode, the partial code string of the second code string is input to the control unit 1824 as a signal 825, yielding a signal 826, and the signal 826 is transferred to the code string rewriting unit 1822. Accordingly, part of the dummy data embedded in the first code string supplied from the code string decomposition unit 1821 is rewritten with the partial code string of the second code string, and the result is transferred to the recording unit 1823.

The playing apparatus and recording apparatus used in embodiments of the present invention have been described above. In the apparatuses, security may be further enhanced by encrypting spectrum coefficient information in the higher range. In that case, the code string rewriting units 1802 and 1822 shown in FIGS. 17 and 19 receive real normalization coefficient information via the control units 1805 and 1824 and replace dummy data therewith, and decode data in the higher range using decryption keys obtained via the control units 1805 and 1824, thereby playing or recording data.

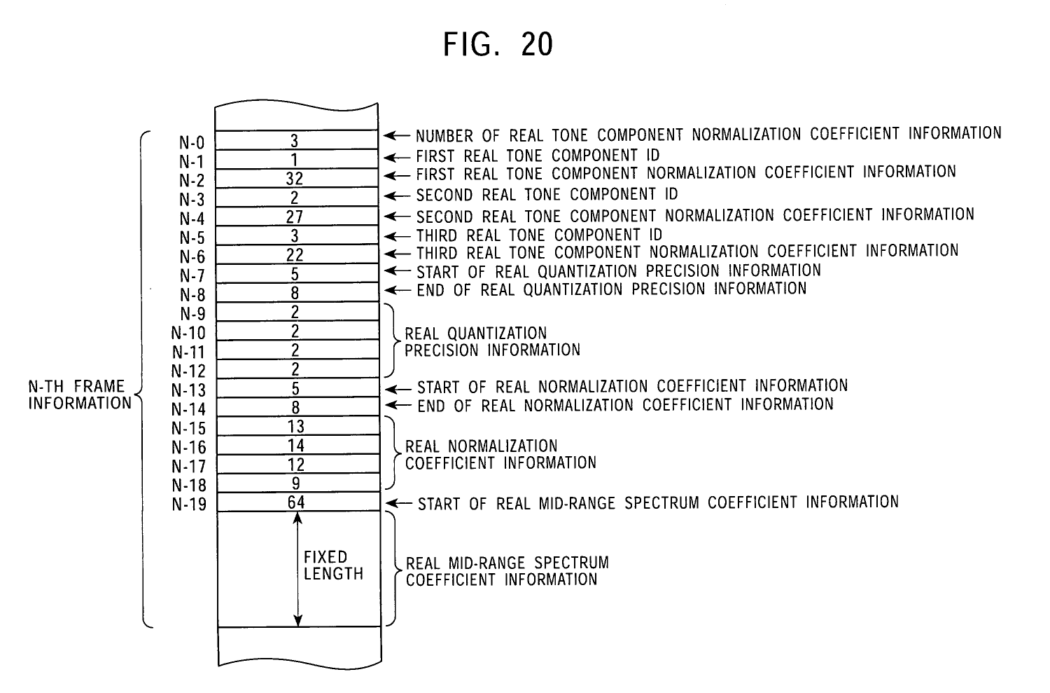

FIG. 20 shows an example format of information for replacing dummy data therewith in a case where tone components are separated as shown in FIG. 10 and encoded as shown in FIG. 13. This changes a playing sound having the spectrum shown in FIG. 15 into a playing sound having the spectrum shown in FIG. 10. In the example shown in FIG. 20, it is assumed that the length of real mid-range spectrum coefficient information that is replaced with dummy data is fixed. In this embodiment, as will be described later, the length of the entire real data of one frame may be fixed or an integer multiple of a predetermined amount of data.

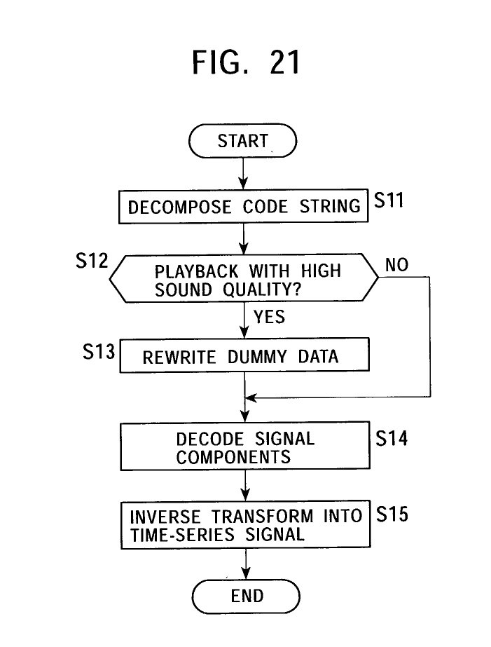

FIG. 21 is a flowchart showing an example procedure of playing in software, used in an embodiment of the present invention. First, in step S11, a code string (a first code string) including dummy data is decomposed. Then, in step S12, it is determined whether data is to be played in high quality. If data is to be played in high quality, in step S13, dummy data in the first code string is replaced with real data (a second code string) for increasing bandwidth, and the procedure proceeds to step S14. Otherwise step S13 is skipped and the procedure directly proceeds to step S14. In step S14 signal components are decoded. In step S15, the decoded signal components are inversely transformed into a time-series signal, whereby sound is played.

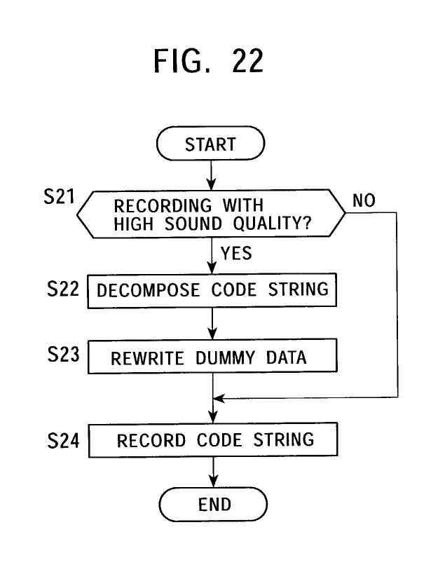

FIG. 22 is a flowchart showing an example procedure of recording in software, used in an embodiment of the present invention. First, in step S21, it is determined whether data is to be recorded in high quality. If data is to be recorded in high quality, a code string (a first code string) including dummy data is decomposed in step S22, the dummy data in the code string is replaced with real data (second code string) for increasing bandwidth in step S23, and then the procedure proceeds to step S24 for recording. Otherwise the procedure proceeds directly from step S21 to step S24.

In the embodiment described above, a code string in a predetermined format, obtained by encoding a signal, is partially replaced, for example, with dummy data of 0s without changing the format, i.e., without changing existing format of the code string. Alternatively, the dummy data may be eliminated to truncate (shorten) the code string.

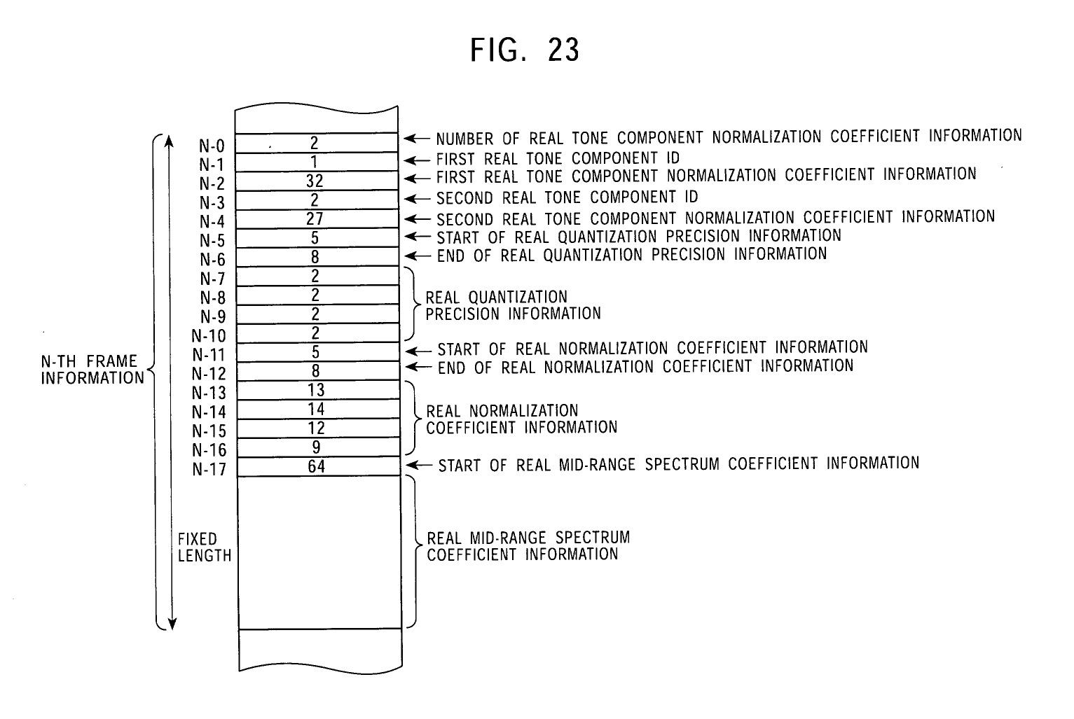

As opposed to the example shown in FIG. 20, in which the amount of data of real mid-range spectrum coefficient information is fixed, in this embodiment, the length of the entire real data of one frame is fixed, as shown in FIG. 23. Thus, for example, the amount of data of mid-range spectrum coefficient information can be varied in accordance with the amount of data of real tone component normalization coefficient information, which differs from frame to frame. Thus, for example, if the length of the entire real data of one frame is sixteen bytes, and if real data is encrypted based on DES, two DES blocks correspond to one frame. Thus, processing of one frame involves processing of two DES blocks, achieving synchronization and facilitating control. FIG. 23 shows one frame of real information in encoded form, in which the length of an entire frame is fixed, and the amount of data of the last real mid-range spectrum coefficient information is variable.

In the embodiment described above, if the amount of data of mid-range spectrum coefficient information is variable, security of a portion with less dummy data is lowered. However, since a large number of frames continuously exists, frames with large amount of dummy data also exist, so that overall security is sufficiently high. Furthermore, the amount of real data of each frame need not necessarily be fixed. For example, if DES is used, although not as simple as the case of fixed amount of data, if the amount of data is an integer multiple of eight bytes, a relatively simple control is allowed by recording the number of frames in units of eight bytes at the beginning of real data and DES-decrypting the corresponding number of blocks.

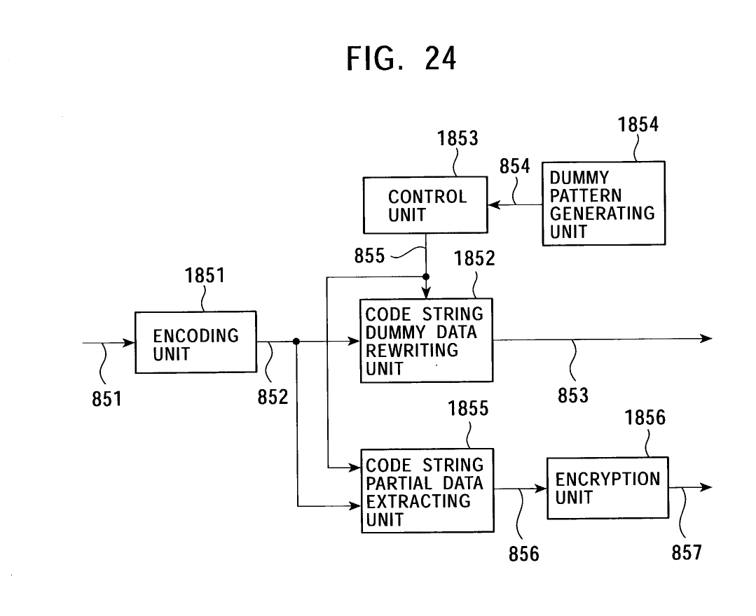

FIG. 24 is a block diagram showing an example of a code string generating apparatus for implementing a code string generating method according to an embodiment of the present invention. Referring to FIG. 24, an input PCM signal 851 is encoded by an encoding unit 1851 to yield a code string 852, and the code string 852 is transferred to a code string dummy data rewriting unit 1852 and to a code string partial data extracting unit 1855. A dummy pattern generating unit 1854 generates information (dummy pattern information) 854 regarding which part (which band) of, for example, normalization coefficient information dummy data is used for, and the dummy pattern information 854 is transferred to a control unit 1853, yielding control information 855; and the control information 855 is transferred to the code string dummy data rewriting unit 1852 and to the code string partial data extracting unit 1855. At this time, the length of the dummy pattern is set so that the final second code string (additional data) described above will be an integer multiple of a predetermined amount of data (e.g., an encryption unit). The code string dummy data rewriting unit 1852 rewrites corresponding portion of the input code string 852 with the dummy data in the control information 855, thereby yielding, for example, a first code string 853 shown in FIG. 14. The code string partial data extracting unit 1855 extracts data in the code string 852 corresponding to the dummy pattern based on the code string 852 and the control information 855, thereby yielding, for example, a second code string 856 for enhancing quality, shown in FIGS. 18 and 23. An encryption unit 1856 may encrypt the second code string 856 as required to yield a code string 857 of an enhanced quality. In that case, the amount of data of the second code string 856 is preferably an integer multiple of an encryption unit.

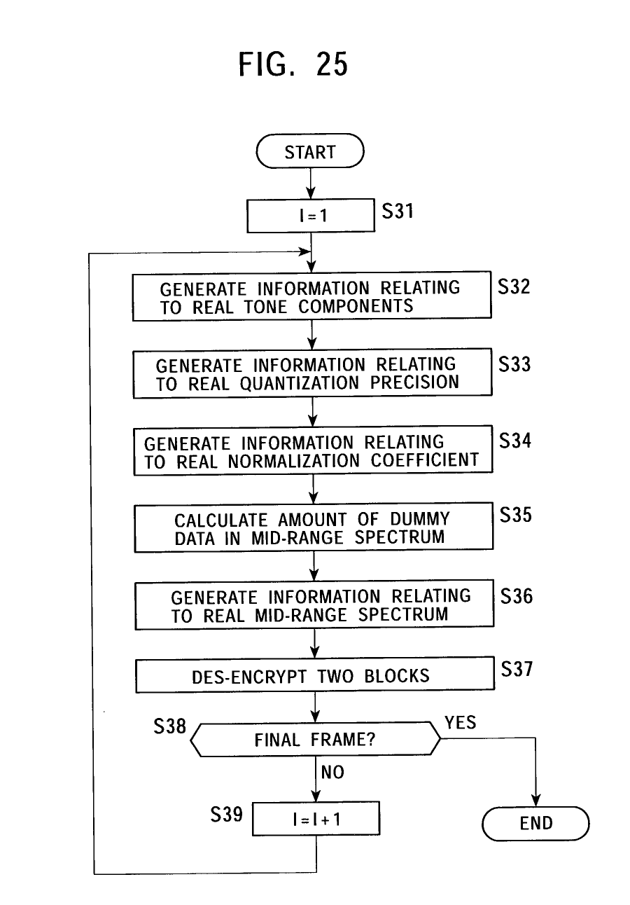

FIG. 25 is a flowchart showing an example procedure for generating real data for enhancing quality for all the frames in the code string generating apparatus according to the embodiment shown in FIG. 24. First, in step S31, one is set in a control variable I. Then, in steps S32, S33, and S34, information relating to real tone components, information relating to real quantization precision, and information relating to real normalization coefficients are generated, respectively. Then, in step S35, the amount of dummy data in the mid-range spectrum is calculated so that the amount of information (the amount of data of the second code string) for enhancing quality for one frame is fixed or an integer multiple of a predetermined amount of data. In step S36, information relating to real mid-spectrum spectrum is generated. In step S37, two blocs are DES-encrypted. In step S38, it is determined whether the current frame is the final frame. If the test in step S38 evaluates to true, the procedure is exited. Otherwise, the control variable I is incremented by one, and the procedure returns to step S32, in which processing for a next frame is executed. Thus, according to the method of the present invention, real data for enhancing quality can be generated in synchronization with a process of block encryption such as DES.

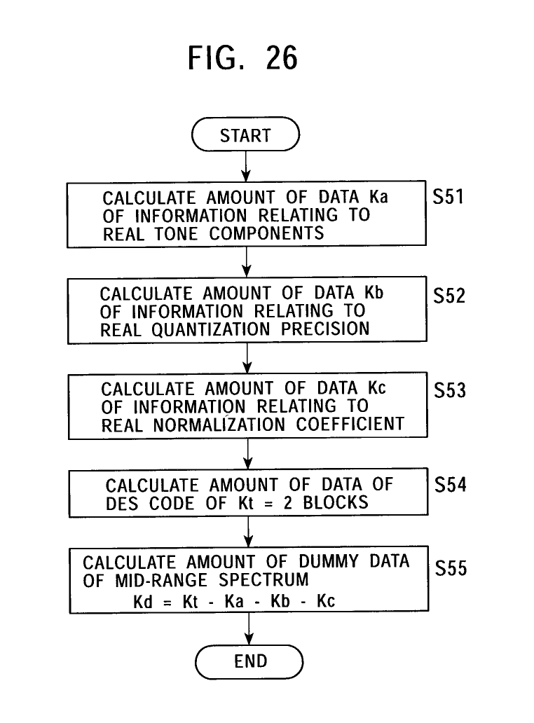

The process of calculating the amount of dummy data in the mid-range spectrum will be described in more detail with reference to a flowchart shown in FIG. 26. Referring to FIG. 26, in step S51, the amount of data Ka of the information relating to real tone components is calculated. In step S52, the amount of data Kb of the information relating to real quantization precision is calculated. In step S53, the amount of data Kc of the information relating to normalization coefficients is calculated. In step S54, for example, Kt is set to be the amount of data of two DES blocks. Then, the amount of dummy data Kd in the mid-range spectrum is calculated by the following equation:

Kd=Kt−Ka−Kb−Kc

Accordingly, the amount of additional data (the second code string) for enhancing quality becomes equal to two blocks of DES encryption units.

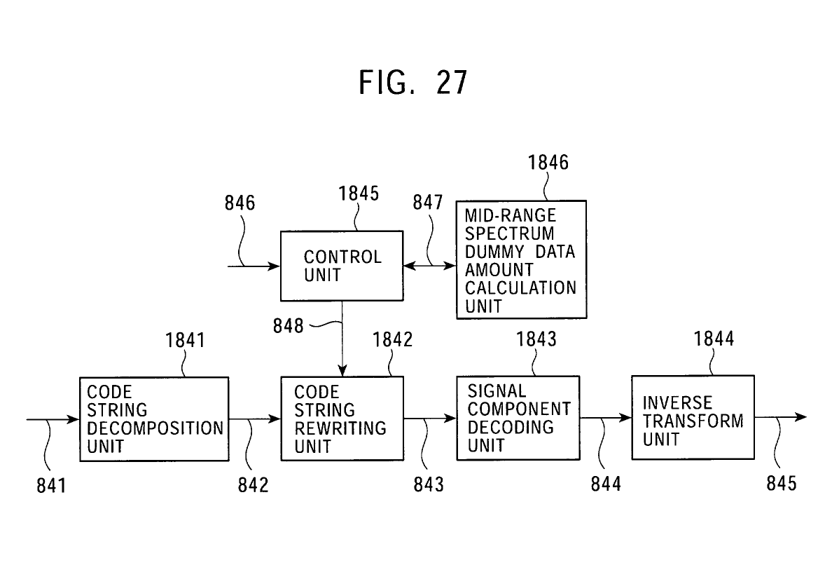

FIG. 27 is a block diagram showing an example of a playing apparatus according to an embodiment of the present invention, which is an improvement of the playing apparatus described with reference to FIG. 17. Referring to FIG. 27, data (second code string) 846 of an enhanced quality, having a frame length that is fixed or an integer multiple of a predetermined amount of data, is transferred to a control unit 1845. Then, a mid-spectrum dummy data amount calculation unit 1846 calculates the amount of data in the mid-range spectrum of the data 846. The control unit 1845 exchanges data 847 with the mid-spectrum dummy data amount calculation unit 1846, and transfers data 848 for replacing the dummy data therewith to a code string rewriting unit 1842. The construction is otherwise the same as that shown in FIG. 17, and parts 1841 to 1845 and signals 841 to 846 correspond to the parts 1801 to 1805 and the signals 801 to 806 in FIG. 17, respectively, so further descriptions thereof will be omitted.

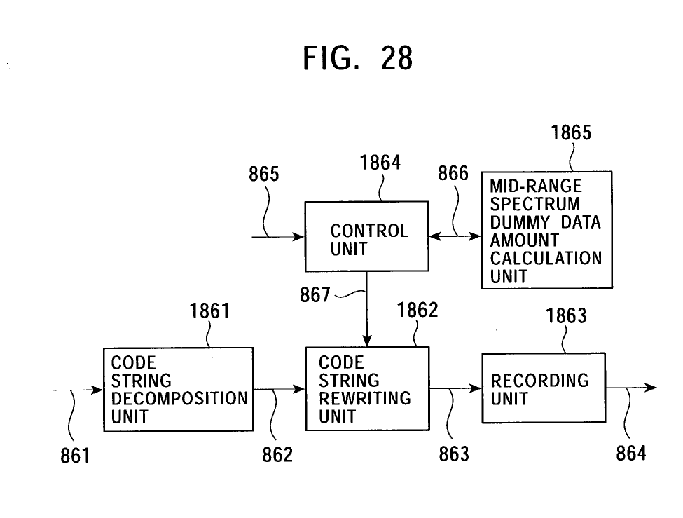

Similarly, FIG. 28 is a block diagram showing an example of a recording apparatus according to an embodiment of the present invention, which is an improvement of the recording apparatus described with reference to FIG. 19. Referring to FIG. 28, data 865 of an enhanced quality, having a fixed frame length, is transferred to a control unit 1864. A mid-spectrum dummy data amount calculating unit 1865 calculates the amount of dummy data in the data 865. The control unit 1864 exchanges data with the mid-spectrum dummy data amount calculation unit 1865, and transfers data 867 for replacing the dummy data therewith to a code string rewriting unit 1862. Parts 1861 to 1864 and signals 861 to 865 in FIG. 28 correspond to the parts 1821 to 1824 and the signals 821 to 825 in FIG. 19, respectively, and so further descriptions thereof will be omitted.

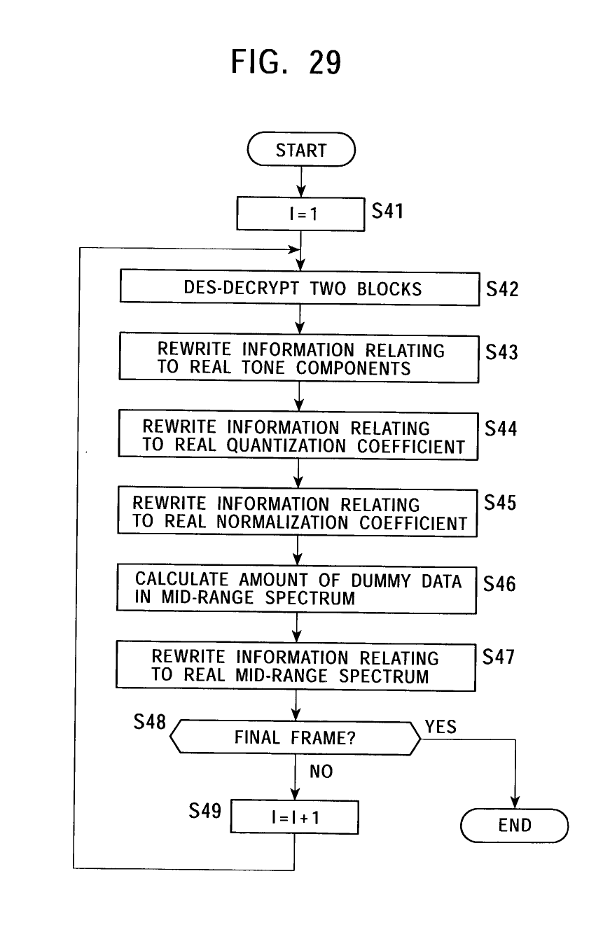

FIG. 29 is a flowchart showing an example procedure for rewriting real data for enhancing quality for all the frames in an embodiment of the present invention. First, in step S41, one is set to a control variable I. In step S42, two DES blocks are decrypted. In steps S43, S44, and S45, information relating to real tone components, information relating to real quantization precision, and information relating to real normalization coefficients are rewritten, respectively. In step S46, the amount of dummy data in the mid-range spectrum is calculated so that the amount of information for enhancing quality for one frame is fixed. Then, in step S47, information relating to real mid-range spectrum is rewritten. In step S48, it is determined whether the current frame is the final frame. If the test in step S48 evaluates to true, the procedure is exited. Otherwise, the procedure proceeds to step S49, in which the control variable I is incremented by one, and then the procedure returns to step S42 for processing of a next frame. Thus, according to the method of the present invention, dummy data can be rewritten with real data for enhancing quality in synchronization with a process of block encryption such as DES.

Although the above description has been made in the context of an example of an audio signal, the present invention may also be applied to an image signal. More specifically, for example, if an image signal is transformed on a block-by-block basis using two-dimensional DCT and the results are quantized using various quantization tables, a process similar to the case of an audio signal can be executed by specifying a dummy quantization table in which components in the higher range are eliminated while using a real quantization table in which the components in the higher range are not eliminated when enhancing image quality.

It is to be understood that a method of the present invention may also be applied to a system in which the entire code string is encrypted and the code string is played while decrypting the code string.

Although the embodiments have been described above in the context of a case where an encoded bit stream is recorded on a recording medium, the present invention may also be applied to transmission of a bit stream. For example, it is possible to allow only those who have obtained real normalization coefficients over the entire bands to play an audio broadcast signal in high quality while allowing others to play the audio broadcast signal only in a relatively low quality such that the content can be grasped to an extent.

The disclosure of Japanese Patent Application No. 2001-342354 filed on Nov. 7, 2001, including specification, claims, drawings, and abstract, is incorporated herein by reference in its entirety.

What is claimed is:

1. A signal processing method for playing or recording a code string obtained by encoding a signal on a frame-by-frame basis, the signal processing method comprising:
a first code string input step of inputting a first code string in which the code string is partially replaced with dummy data;
a second code string input step of inputting a second code string;
a processing step of executing a predetermined process on each unit of a predetermined amount of data of the second code string;
a rewriting step of rewriting the dummy data in the first code string with the second code string to replace the dummy data; and
a decoding step of decoding the rewritten code string;
wherein, in the second code string, an amount of data relating to or associated with one frame of the original code string is an integer multiple of the predetermined amount of data.

2. A signal processing method according to claim 1, wherein the amount of data of one frame of the second code string is fixed.

3. A signal processing method according to claim 1, wherein an encryption process is performed on the second code string, the predetermined process is a decryption process of decrypting the encrypted second code string, and the predetermined amount of data is a decryption unit of the decryption process.

4. A signal processing apparatus for playing or recording a code string obtained by encoding a signal on a frame-by-frame basis, the signal processing apparatus comprising:
first code string input means for inputting a first code string in which the code string is partially replaced with dummy data;
second code string input means for inputting a second code string;
processing means for executing a predetermined process on each unit of a predetermined amount of data of the second code string;
rewriting means for rewriting the dummy data in the first code string with the second code string to replace the dummy data; and
decoding means for decoding the rewritten code string;
wherein, in the second code string, an amount of data relating to or associated with one frame of the original code string is an integer multiple of the predetermined amount of data.

5. A signal processing apparatus according to claim 4, wherein the amount of data of one frame of the second code string is fixed.

6. A signal processing apparatus according to claim 4, wherein an encryption process is performed on the second code string, the predetermined process is a decryption process of decrypting the encrypted second code string, and the predetermined amount of data is a decryption unit of the decryption process.

7. A code string generating method comprising:
an encoding step of encoding an input signal to generate a code string in a predetermined format;
a first code string generating step of rewriting part of the code string in the predetermined format with dummy data to generate a first code string; and
a second code string generating step of generating a second code string including the part of the code string in the predetermined format, having been replaced with the dummy data;
wherein, in the second code string, an amount of data relating to or associated with one frame of the original code string is an integer multiple of the predetermined amount of data.

8. A code string generating method according to claim 7, wherein the amount of data of one frame of the second code string is fixed.

9. A code string generating method according to claim 7, wherein an encryption process is performed on the second code string, and the predetermined amount of data is an encryption unit of the encryption process.

10. A code string generating method according to claim 7, wherein an input signal is spectral-transformed and split into bands in the encoding step, generating a code string in a predetermined format including quantization precision information, normalization coefficient information, and spectrum coefficient information for each of the bands, and the dummy data used in the first code string generating step includes dummy data for part of at least one of the quantization precision information, the normalization coefficient information, and the spectrum coefficient information.

11. A code string generating method according to claim 10, wherein dummy data for the spectrum coefficient information is encoded using variable-length codes.

12. A code string generating method according to claim 10, wherein the dummy data includes dummy data for normalization coefficient information of a tone spectrum component.

13. A code string generating apparatus comprising:
encoding means for encoding an input signal to generate a code string in a predetermined format;
first code string generating means for rewriting part of the code string in the predetermined format with dummy data to generate a first code string; and
second code string generating means for generating a second code string including the part of the code string in the predetermined format, having been replaced with the dummy data;
wherein, in the second code string, an amount of data relating to or associated with one frame of the original code string is an integer multiple of the predetermined amount of data.

14. A code string generating apparatus according to claim 13, wherein the amount of data of one frame of the second code string is fixed.

15. A code string generating apparatus according to claim 13, wherein an encryption process is performed on the second code string, and the predetermined amount of data is an encryption unit of the encryption process.

16. A code string generating apparatus according to claim 13, wherein an input signal is spectral-transformed and split into bands by the encoding means, generating a code string in a predetermined format including quantization precision information, normalization coefficient information, and spectrum coefficient information for each of the bands, and the dummy data used by the first code string generating means includes dummy data for part of at least one of the quantization precision information, the normalization coefficient information, and the spectrum coefficient information.

17. A code string generating apparatus according to claim 16, wherein dummy data for the spectrum coefficient information is encoded using variable-length codes.

18. A code string generating apparatus according to claim 16, wherein the dummy data includes dummy data for normalization coefficient information of a tone spectrum component.
